(19) United States
(12) Patent Application Publication
(10) Pub. No.: US 2026/0265087 A1
(43) Pub. Date: Sep. 10, 2026

(54) PORTABLE APPARATUS AND METHOD FOR PURIFYING WATER FOR DRINKING FROM SOURCES THAT MAY CONTAIN NUCLEAR, BIOLOGICAL, OR CHEMICAL CONTAMINANTS (NBC)

(71) Applicants: Kenneth James Renfrew, Huntersville, NC (US); Robert Callum Renfrew, Huntersville, NC (US); Ann Renfrew, Huntersville, NC (US)

(72) Inventors: Kenneth James Renfrew, Huntersville, NC (US); Robert Callum Renfrew, Huntersville, NC (US); Ann Renfrew, Huntersville, NC (US)

(21) Appl. No.: 19/560,298

(22) Filed: Mar. 9, 2026

Related U.S. Application Data
(60) Provisional application No. 63/768,913, filed on Mar. 8, 2025.
(60) Provisional application No. 63/850,217, filed on Jul. 24, 2025.
(60) Provisional application No. 63/960,691, filed on Jan. 14, 2026.

(51) Int. Cl. C02F 1/44; C02F 1/00

(52) U.S. Cl. CPC C02F 1/441; C02F 1/004; C02F 2201/004; C02F 2201/005

(57) ABSTRACT

A water purification apparatus for removing nuclear, biological and chemical contaminants from water, including toxic industrial chemicals (TICs) and toxic industrial materials (TIMs). One-, two- and three-chamber bladders, bags or hard-shell casings connected to a reverse osmosis filter assembly in either dead-end or cross-flow modes provide chambers to receive raw water, optionally receive and deliver retentate and/or receive purified water. A first contaminated water bag has a sealable inlet, a sealable outlet and a soda-siphon-style valve. A second or third clean water bag or casing has a sealable inlet and a sealable outlet. A hose or manifold is secured between the first and second bag with a reverse osmosis cartridge secured in-line with the hose. The reverse osmosis cartridge includes an optional first pre-filtration stage depth filter, an optional second pre-filtration stage activated carbon filter and a reverse osmosis filter. A compressed air, nitrogen or other inert gas soda siphon style, or pneumatic tool type cartridge secured to the soda-syphon-style or pneumatic-tool-style valve infuses high-pressure gas into the first contaminated water bag to urge contaminated water in the first contaminated water bag or chamber through the reverse osmosis cartridge into the second or third clean water bag or chamber. Adapters to receive other sources of pressurized inert gases and a single-bag system improve adaptability and simplicity of the water purification system.

### CROSS-REFERENCE TO RELATED APPLICATIONS

This Regular Utility Application claims the benefit of U.S. Provisional Patent Application Ser. No. 63/768,913, filed Mar. 8, 2025, U.S. Provisional Patent Application Ser. No. 63/850,217, filed Jul. 24, 2025 and U.S. Provisional Patent Application Ser. No. 63/960,691, filed Jan. 14, 2026, the contents all of which are incorporated by reference.

### FIELD OF THE DISCLOSURE

The disclosure relates generally to water purification systems. More particularly, the disclosure relates to a portable apparatus and method for purifying fresh water, brackish water and salt water that may be contaminated with nuclear, biological or chemical substances. Still more particularly, the disclosure relates to individual water treatment devices that reduce and/or remove toxic industrial chemicals, (referred to herein as TICs), and toxic industrial materials, (referred to herein as TIMs), from any indigenous fresh water sources.

### BACKGROUND OF THE DISCLOSURE

To filter liquids, and in particular water, of undesired contaminants, filters and/or purification media e.g., granular resins, granulated carbon, carbon fiber, soda lime and the like, are used in enclosed filter housings to effectuate contaminant removal. Innumerable filtration devices and systems have been developed for the cleaning and purification of a wide range of liquids.

One such filtration method used to purify water is reverse osmosis. There are several reverse osmosis devices that have been developed for portable, on-site use. Such portable filtration devices require a hand pump or similar force-inducing apparatus to urge fluids through a reverse osmosis filter. Typical reverse osmosis filters require the application of at least 60 psi of pressure to successfully urge contaminated fluids through the filter. As is well known to those that have used such water filtration apparatuses, the number of pump cycles and the amount of force needed to successfully urge fluid through the filter is both laborious and time-consuming. Moreover, the amount of fluid produced via the amount of energy input is relatively small, often measured in ounces rather than in quarts or gallons. These challenges can be particularly acute in outdoor, emergency and austere environments where chemicals and electrical power may not be available readily. What is needed is a portable water filtration device that can successfully eliminate nuclear, biological and chemical contaminants including TICs and TIMs from water with minimal effort and maximum yield. Such a water purification apparatus should involve low mass for transportability into harsh environments, mechanical simplicity and reliability under short duty cycles, and operability absent chemical, vacuum and/or electrical power.

It is thus an object of the disclosure to provide a portable water filtration apparatus that can effectively remove nuclear, biological and chemical contaminants from contaminated water sources without the need for the application of manual force or minimal manual force. It is a further object of the disclosure to provide an apparatus and method of water purification that can yield high volumes of clean water from a relatively small apparatus. It is yet a further object of the disclosure to remove chemical contaminants to levels mandated by the U.S. Defense Health Agency: Defense Centers for Public Health-Aberdeen. It is another object of the disclosure to extract water contaminants to a level that meets or exceeds the microbiological mitigation requirements set forth in the NSF protocol P248: military applications of microbiological water purifiers, and more particularly in NSF P248.02-2025 emergency water purification requirements. These and other objects of the disclosure will become apparent from a reading of the following summary and detailed description of the disclosure.

### SUMMARY OF THE DISCLOSURE

In one aspect of the disclosure, a dual-bag or dual-bladder apparatus is provided in which the first bag, designated as a contaminated water bag, is connected to a second bag, designated as a clean water bag. The first water bag has an inlet port positioned at a top of the bag that may be threaded to receive a threaded plug. The threaded plug seals the bag after contaminated water has been introduced into the bag. An outlet is positioned at a bottom end of the bag to permit liquids, e.g., water, in the bag to flow out of the bag. The outlet may or may not have a valve to selectively prevent or permit the flow of water out of the bag.

The clean water bag is a resilient, flexible bag formed with a valved inlet port and a valved outlet port. In one embodiment, a hose connects the contaminated water bag to the clean water bag. A first end of the hose is secured to the first bag outlet and may be formed from flexible material. A second end of the hose is secured to the inlet of the clean water bag. A reverse osmosis filter apparatus is secured in-line with the hose between the first end and the second end. The reverse osmosis filter may have a first pre-filtration stage in the form of a depth filter to retain bulk particulate matter. An optional second pre-filtration stage in the form of an activated carbon filter retains organic matter present in the contaminated water. After passing through the first and second pre-filtration stages, the still contaminated water passes through the reverse osmosis filter and into the clean water bag via the hose. An optional bleed valve may be connected to the reverse osmosis filter apparatus to bleed off retentate during a filtration procedure.

In another aspect of the disclosure, the contaminated water bag is formed with a pressure relief valve in fluid communication with the chamber formed by the contaminated water bag. The contaminated water bag is further formed with a soda siphon-type inlet valve. A soda siphon cartridge/spigot is provided for insertion into the soda siphon inlet valve.

To perform the water purification function of the apparatus, contaminated water is flowed into the contaminated water bag via the inlet port. Once the bag is filled, the inlet port plug is secured to the inlet port and the valve to the outlet port, if present, is opened to permit the flow of contaminated water from the contaminated water bag into the hose. The inlet valve of the clean water bag is also opened before the filtration process is initiated. The outlet valve(s) of the clean water bag are closed during the filtration procedure. An air vent/valve (not shown) may be incorporated into the clean water bag to permit the expulsion of air when filtered water is urged into the clean water bag.

To initiate the water filtration process, the soda siphon cartridge/spigot is inserted into the soda siphon inlet valve either manually or with a soda siphon cartridge gun or manually torqued into place if mating threading is present on the cartridge and the valve. Once properly inserted, pressurized inert gas stored in the soda siphon cartridge is released rapidly into the contaminated water bag. This pressurizes the chamber of the contaminated water bag to approximately 75 psi, which is sufficient pressure to urge the contaminated water through the two pre-filtration filters and the reverse osmosis filter, and into the clean water bag as clean, purified water void of all nuclear, biological and chemical contaminants.

In another aspect of the disclosure, a single-bag apparatus is provided in which the bag or bladder is designated as a contaminated water bag. The contaminated water bag defines a chamber and has an inlet port positioned at a top of the bag that may be threaded to receive a threaded plug. The threaded plug seals the bag after contaminated water has been introduced into the bag. An optional secondary inlet port on the front or back surface of the bag or bladder with a threaded cap may be included to permit rapid filling of the bag/bladder such as via submersion in a water body, e.g., a stream, pond or lake. An outlet positioned at a bottom end of the bag permits liquids, e.g., water, in the bag to flow out of the bag. The outlet may or may not have a valve to selectively prevent or permit the flow of water out of the bag. Portions of the outlet are structured as a connector to permit a reverse osmosis filtration assembly, formed with a connector corresponding to the connector portion of the bag outlet, to be secured to the bag.

The reverse osmosis filtration assembly includes a reverse osmosis filter as a final stage and an optional pre-filtration stage in the form of a depth filter, upstream the reverse osmosis filter, to retain bulk particulate matter. An optional second pre-filtration stage in the form of an activated carbon filter may be included downstream the pre-filtration stage and upstream of the reverse osmosis filter to retain organic matter that may be present in the contaminated water. After passing through the pre-filtration stage and, if present, second pre-filtration stage, the still contaminated water passes through the reverse osmosis filter and exits via a filtration assembly outlet. An optional bleed valve may be connected to the reverse osmosis filter assembly to permit retentate to be bled off during a filtration procedure. the outlet may have portions formed as a connector to permit the filtration assembly to be connected to other water-containment and/or water treatment apparatus. Alternatively, the outlet may be formed without any additional features to permit the free flow of purified water out of the filtration assembly. This option permits the direct transfer of purified water to other vessels such as a cup, flask, water bottle and the like. It also permits water to be drunk directly from the outlet end of the filtration assembly with or without a sip tube. In a further alternative embodiment, the filtration assembly may be formed with a valve to permit the selective release or retention of purified water in the filtration assembly.

The contaminated-water bag is formed with a pressure relief valve set to a preselected pressure in fluid communication with the chamber formed by the contaminated-water bag. The contaminated-water bag is further formed with a soda siphon-type inlet valve. A soda siphon cartridge/spigot is provided for insertion into the soda siphon inlet valve. In an alternative embodiment, a connection adapter is connected to the soda siphon-type inlet valve to permit other forms of canisters and containers of compressed air and/or gas to be infused into the contaminated-water bag. In a further alternative embodiment, a connector and valve assembly, different from the soda siphon-type inlet valve, is secured directly to the contaminated-water bag to permit alternative pressurized containers with connector features corresponding to the connection features of the connector and valve assembly to be secured to the connector.

To perform the water purification function of the apparatus, regardless of the embodiment, contaminated water is flowed into the contaminated-water bag via the inlet port. Once the bag is filled, the inlet port plug is secured to the inlet port and the valve to the outlet port, if present, is opened to permit the flow of contaminated water from the contaminated water bag into the hose of the first disclosed embodiment, and into the filtration assembly of the second disclosed embodiment. If present, the inlet valve of the clean-water bag is also opened before the filtration process is initiated. The outlet valve(s) of the clean-water bag are closed during the filtration procedure. Any vent valve in the clean-water bag will be open to permit air trapped in the clean-water bag to be purged out during a filtration procedure. Whether or not a clean-water bag is present, any outlet valve of the filtration assembly is maintained in an open position during a filtration process.

To initiate the water filtration process, the soda siphon cartridge/spigot is inserted into the soda siphon inlet valve either manually or with a soda siphon cartridge gun, or manually torqued into place if mating threading is present on the cartridge and valve. Once properly inserted, pressurized inert gas, stored in the soda siphon cartridge, is released rapidly into the contaminated water bag. This pressurizes the chamber of the contaminated water bag to approximately 75 psi, which is sufficient pressure to urge the contaminated water through the two pre-filtration filters, the reverse osmosis filter and into the clean water bag as clean, purified water void of all nuclear, biological and chemical contaminants. If an alternative compressed air/gas connector/container is used, the same procedure used for the soda siphon cartridge is followed by simply substituting the air/compressed gas container for the soda siphon cartridge.

In a further aspect of the disclosure, a pressure-driven, batch-operated water purification apparatus employs a compressed air, lightweight disposable cartridge adapted to be manually quick-connected to a flexible bladder laden with untreated water. A modular pre-filtration stage in the form of a depth filter is secured downstream the bladder to retain bulk particulate matter. An optional second pre-filtration stage in the form of an activated carbon filter may be included downstream the pre-filtration stage and upstream of the reverse osmosis filter to retain organic matter that may be present in the contaminated water. After passing through the pre-filtration stage and, if present, second pre-filtration stage, the partially-purified water passes through the reverse osmosis filter secured downstream the pre-filtration stage(s) and exits via a filtration assembly outlet. This outlet may have portions formed as a connector to permit the filtration assembly to be connected to other water-containment and/or water treatment apparatus. Alternatively, the outlet may be formed without any additional features to permit the free flow of purified water out of the filtration assembly. This option permits the direct transfer of purified water to other vessels such as a cup, flask, water bottle and the like. It also permits water to be drunk directly from the outlet end of the filtration assembly. In a further alternative embodiment, the filtration assembly may be formed with a valve to permit the selective release or retention of purified water in the filtration assembly.

In another aspect of the disclosure, a water purification apparatus with a three-chamber bladder incorporates a cross-flow configuration to recycle retentate collected by an attached reverse osmosis filter. The three-chamber bladder is contained in a single hydration pack that may include a hard shell, a hard shell with the bladder permanently secured therein, a hard shell with a replaceable bladder secured therein, or the elastomeric three-chamber bladder without a hard shell. The bladder, particularly without a hard-shell casing, may be arranged connected or ergonomically arranged to fit about a human body to equally distribute the weight of the bladder. If a hard-shell is included, the water purification apparatus can be fashioned as a back pack, front pack or incorporated into larger apparatus such as a Molle unit used by the military. Regardless of the configuration, each chamber of the tri-chamber bladder will have a dedicated outlet or inlet port secured to a port on a fixed or replaceable reverse osmosis cartridge to perform the water purification process. Additional ports are positioned on each bladder chamber to permit the forceful ejection of any liquid contents within a specific bladder chamber.

The portable water filtration apparatus embodiments disclosed herein are structured to provide reliable purification of water from unknown or contaminated water sources where infrastructure, electricity, and/or chemical treatment is unavailable. Illustrative uses include warfare, disaster response, humanitarian aid, expeditionary operations and individual survival scenarios. The water filtration apparatuses may be carried by hand, by a shoulder strap, by a waste belt, or attached to a backpack. The apparatus does not require electricity or any source of energy to perform the filtration function. These and other aspects of the disclosure will become apparent from a review of the appended drawings and a reading of the following detailed description of the disclosure.

### BRIEF DESCRIPTION OF THE DRAWINGS

FIG. 1 is a perspective view in partial phantom of a portable water purification apparatus according to one embodiment of the disclosure.

FIG. 2 is a planar view in elevation of the portable water purification apparatus shown in FIG. 1 in an expanded orientation.

FIG. 3 is a side view in elevation of the portable water purification apparatus shown in FIG. 1.

FIG. 4 is a sectional view of an inlet end of a contaminated water bag according to the embodiment of the disclosure shown in FIG. 1.

FIG. 5 is a sectional view of an outlet end of a contaminated water bag according to the embodiment of the disclosure shown in FIG. 1.

FIG. 6 is a sectional view of an inlet end of a clean water bag according to the embodiment of the disclosure shown in FIG. 1.

FIG. 7 is a sectional view of an outlet end of a clean water bag according to the embodiment of the disclosure shown in FIG. 1.

FIG. 8 is a sectional view in elevation of a depth filter, carbon filter and a reverse osmosis filter in a filter assembly according to one embodiment of the disclosure.

FIG. 9 is a sectional view of a contaminated water bag with an adapter secured to a soda siphon-type inlet valve according to another embodiment of the disclosure.

FIG. 10 is a sectional view of a contaminated water bag with a compressed air/gas cylinder connector according to yet another embodiment of the disclosure.

FIG. 11 is a sectional view of a contaminated-water bag with a threaded outlet according to a further embodiment of the disclosure.

FIG. 12 is a sectional view of a contaminated-water bag with a bayonet-style connector outlet according to a yet further embodiment of the disclosure.

FIG. 13 is a sectional view in elevation of a depth filter and a reverse osmosis filter in a filtration assembly according to another embodiment of the disclosure.

FIG. 14 is a side view in elevation of a threaded inlet port for a filtration assembly according to one embodiment of the disclosure.

FIG. 15 is a side view in elevation of a click-lock, bayonet-style inlet port connector for a filtration assembly according to another embodiment of the disclosure.

FIG. 16 is a top, side perspective view of a click-lock, bayonet-style port connector according to a further embodiment of the disclosure.

FIG. 17 is a top, side perspective view of a click-lock, bayonet-style port connector according to a yet further embodiment of the disclosure.

FIG. 18 is a top, side perspective view of a click-lock, bayonet-style port connector according to a still further embodiment of the disclosure,

FIG. 19 is a top, side perspective view of a click-lock, bayonet-style port connector according to another embodiment of the disclosure,

FIG. 20 is a side view in elevation of a threaded outlet port for a filtration assembly according to a yet further embodiment of the disclosure.

FIG. 21 is a side, sectional view of a filtration apparatus according to another embodiment of the disclosure.

FIG. 22 is a solid model perspective view of the filtration apparatus shown in FIG. 21.

FIG. 23 is a front view in partial phantom of a cross-flow hydration apparatus with an elastomeric tri-chamber bladder according to yet another embodiment of the disclosure.

FIG. 24 is a front view in partial phantom of a cross-flow hydration apparatus with a hard-shell outer casing and replaceable elastomeric tri-chamber bladder according to still another embodiment of the disclosure.

FIG. 25 is a front view in partial phantom of a tri-chamber bladder cross-flow hydration apparatus with a with a hard-shell outer casing and a fixed elastomeric bladder according to a further embodiment of the disclosure.

FIG. 26 is a front view in partial phantom of a hydration pack with a hard-shell casing with three rigid internal chambers according to a yet further embodiment of the disclosure.

FIG. 27 is a partial side view in elevation of a water purification apparatus with a hard-shell outer casing with a fixed elastomeric tri-chamber bladder according to the embodiment of the disclosure shown in FIG. 26.

FIG. 28 is a partial side view in elevation of a water purification apparatus with a hard-shell outer casing with a replaceable elastomeric tri-chamber bladder according to the embodiment of the disclosure shown in FIG. 25.

FIG. 29 is a partial side view in elevation of a water purification apparatus with an elastomeric tri-chamber bladder according to the embodiment of the disclosure shown in FIG. 24.

FIG. 30 is a partial side view in elevation of a water purification apparatus with a hard-shell casing and three rigid internal chambers according to the embodiment of the disclosure shown in FIG. 27.

FIG. 31 is a back view in elevation of a water purification apparatus with a hard-shell casing with an elastomeric tri-chamber bladder positioned in the casing with a bladder access door and a filter access door according to the embodiment of the disclosure shown in FIG. 21.

FIG. 32 is a partial side view of the water purification apparatus shown in FIG. 28 with the bladder access door partially open.

### DETAILED DESCRIPTION OF THE DISCLOSURE

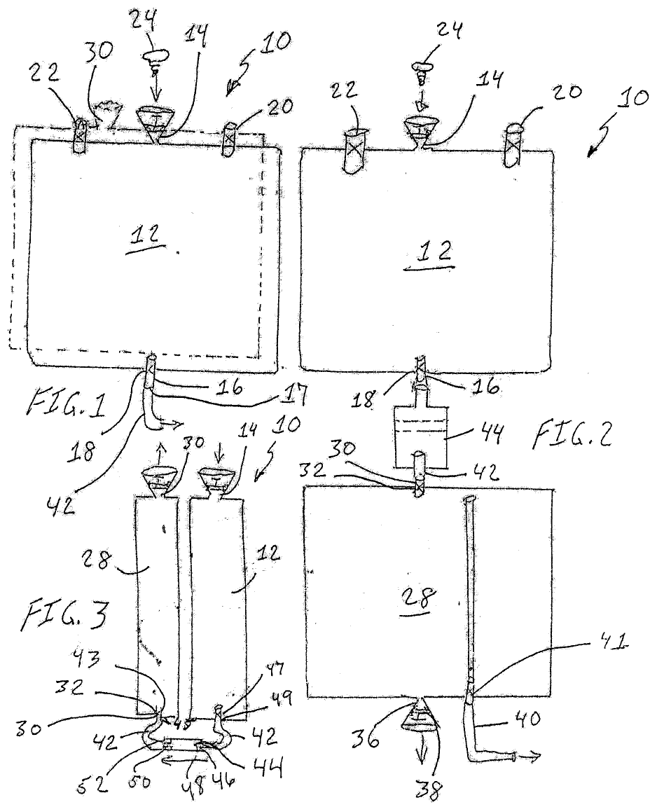

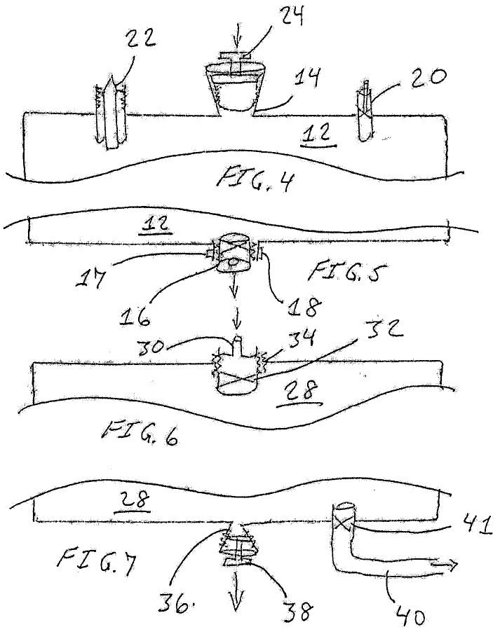

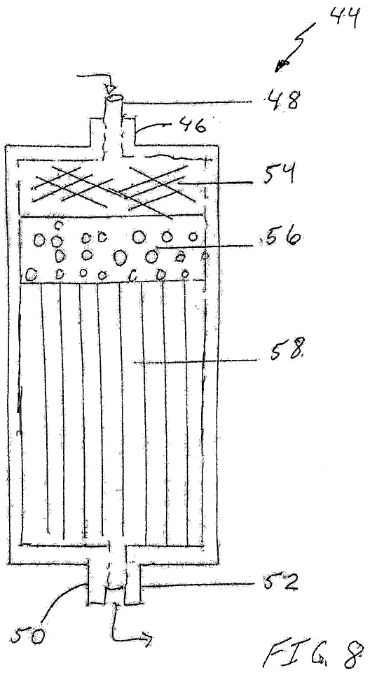

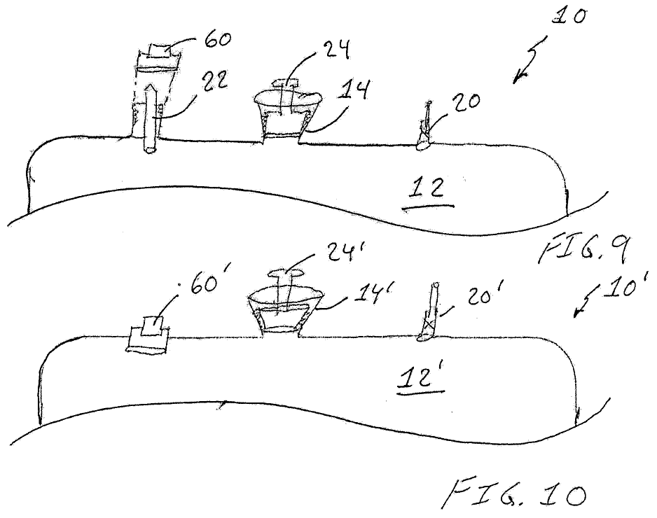

Referring now to FIGS. 1-8, in one aspect of the disclosure, a water purification apparatus, designated generally as 10 includes a first bag or bladder 12 designated as a contaminated water bag. First bag 12 is essentially a flexible, pliable and/or stretchable bag that can expand with the introduction of liquids and/or gases into a volumetrically modifiable first bag chamber defined by the wall of first bag 12. First bag 12 has a first bag inlet 14 extending from a top end of first bag 12 with optional internal or external threading to receive a first bag inlet plug 24 with optional external or internal threading dimensioned and spaced to match the dimensions and spacing of the first bag inlet internal or external threading. In an alternate embodiment, inlet plug 24 may be a tapered elastomeric plug that secures into first bag inlet 14 via a friction fit or a plug with bayonet-style engagement features. First bag inlet 14 is in fluid communication with the first bag chamber. It should be understood that the top end of first bag 12 is determined by the location of first bag inlet 14.

First bag 12 further includes a first bag outlet 16 that extends from a bottom end of first bag 12. A first bag outlet valve 18 provides a means to open and close the outlet. An end of first bag outlet 16 may be formed as, or have secured thereto, a male or female quick disconnect 17 for attachment to a hose disclosed in detail hereinbelow. It should be understood that outlet valve 18 and quick connect 17 can be a combination component. First bag outlet 16 is in fluid communication with the first bag chamber. First bag outlet valve 18 is closed initially when filling first bag 12 with unfiltered water or other liquid.

First bag 12 further includes a pressurized-gas-receiving port in the form of a soda-siphon-type inlet and valve assembly port 22 secured to a top end of first bag 12. Soda-siphon-type inlet and valve assembly port 22 is essentially a check valve that permits the attachment of a soda-siphon-type cartridge/spigot to introduce pressurized gas into the apparatus as disclosed in more detail herein. It should be understood that the location of soda-siphon-type inlet and valve assembly port 22 is not limited to the top end of first bag 12 but may be positioned on any end or outer surface of first bag 12. Soda-siphon-type inlet valve port 22 is in fluid communication with the first bag chamber.

Water purification apparatus 10 further includes a second bag or bladder 28, designated as a clean-water bag. Like first bag 12, second bag 28 is essentially a flexible, pliable and/or stretchable bag that can expand with the introduction of liquids and/or gases into a volumetrically modifiable second bag chamber defined by the wall of second bag 28. Second bag 28 has a second bag inlet 30 extending from a top end of second bag 28 with a second bag inlet valve 32 and a second bag inlet male or female quick connect 34 formed on, or attached thereto. Second bag inlet 30 is in fluid communication with the second bag chamber. It should be understood that the top end of second bag 28 is determined by the location of second bag inlet 30.

Second bag 28 further includes a second bag outlet 36 that extends from a bottom end of second bag 28. A second bag outlet valve 38 in the form of a check valve provides a means to ensure one-way flow out of second bag 28. Any reverse flow into second bag 28 via second bag outlet 36 is prevented by second bag outlet valve 38. Second bag outlet 36 is in fluid communication with the second bag chamber and may function as a drinking port. Second bag outlet valve 38 is closed initially when filling first bag 12 with unfiltered water or other liquid. A gas vent and valve assembly (not shown) may be secured to second bag 28 to permit the purging of air or other gases and/or liquids when second bag 28 is receiving filtered liquid from first bag 12.

Also extending from a bottom end of second bag 28 is an optional flexible sip tube 40. A sip tube valve 41 in the form of a check valve permits one-way transfer of purified water out of second bag 28 via sip tube 40. A proximal end of sip tube 40 can extend within second bag 28 to allow the bag to be positioned in different orientations and allow for purified water to be sucked out of the bag via sip tube 40.

A bag linking hose 42 connects first bag 12 to second bag 28 via first bag outlet 16 and second bag inlet 30. Linking hose 42 is structured to be flexible with a first hose male or female quick connect 43 formed on, or attached to, a first hose end 45 that attaches to quick connect 17 of first bag outlet 16. A second hose male or female quick connect 47 formed on, or attached to, a second hose end 49 attaches to second bag inlet quick connect 34 to join linking hose 42 to second bag inlet 30. It should be understood that the orientation of the quick connect valves are set so that a male quick connect segment on one component can attach to a female quick connect segment on an adjacent component with the pairs of quick connect male and female connectors reversible for each connection. It also should be understood that connectors, other than quick-connect connectors may be used to secure the various apparatus elements together and remain within the scope of the disclosure.

Secured in-line with linking hose 42 is a reverse osmosis filter assembly, designated generally as 44 in FIG. 8. Reverse osmosis filter assembly 44 can be permanently affixed to linking hose 42 or secured thereto with quick connect assemblies like the connections used between the linking hose and the bags. In one embodiment, reverse osmosis filter assembly 44 has an inlet 46 with a first filter quick connect 48. First filter quick connect 48 can be either a male or a female quick connect. A corresponding male or female quick connect is formed on, or attached to, linking hose 42 to secure the hose to the reverse osmosis filter assembly on the end of the filter corresponding to the outlet end of first bag 12.

Reverse osmosis filter assembly 44 further has an outlet 50 with a second filter quick connect 52. Second filter quick connect 52 can be either a male or female quick connect connector. A corresponding male or female quick connect connector is formed on, or attached to, a segment of linking hose 42 to secure the hose to the reverse osmosis filter on the end of the filter corresponding to the inlet end of second bag 28. In one embodiment, all stages of filtration are contained in a single filter cartridge/assembly equipped with a quick connect male inlet and a quick connect female outlet with corresponding female quick connect first bag outlet and male quick connect second bag inlet. The male/female orientations of inlet and outlet prevent the cartridge from being assembled in the incorrect direction of water flow. Reverse osmosis filter assembly 44 also may include a retentate bleed valve 53 to permit the release of retentate during a filtration procedure. If bleed valve 53 is present, to encourage preferential flow through the reverse osmosis membrane, bleed valve 53 has a constricted internal diameter that creates back pressure.

Reverse osmosis filter assembly 44 is in a capsule or in a cartridge form with three distinct sections. A first pre-filtration section contains a depth filter 54 formed with pore sizes and a porosity configured to capture silt, large particulate matter and bulk debris. This filter is constructed illustratively from materials that are fibrous and non-woven. Illustrative examples are glass fiber, polypropylene and polyester as well as other materials commonly known in the art for constructing depth filters. A second pre-filtration section 56 contains activated carbon to capture and retain any organic matter and organic chemical contaminants in the water being purified. A third section is a reverse osmosis filter 58 that will capture and retain any remaining nuclear, biological and chemical contaminants. Common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors.

To operate water purification apparatus 10, unpurified water is collected into the contaminated water bag, first bag 12. In this initial step, any manually-operated valves (other than pressure relief, or vent and vent valve assemblies) are placed in the closed position. Threaded plug 24 is unscrewed from first bag inlet 14 to permit unpurified water to be poured into the inlet, which may have a diameter of approximately one inch. It should be understood that the diameter of the inlet can be set to any dimension and remain within the scope of the disclosure. Once first bag 12 has been filled, threaded plug 24 is secured back into first bag inlet 14. A threaded plug is used to ensure the bag remains closed when pressurized. Other mechanical interference engagement features, e.g., bayonet-style connections, may be used to secure plug 24 in first bag inlet 14. Both first bag 12 and second bag 28 are constructed to have high burst pressure tolerances as disclosed in more detail below. A pressure relief valve 20 is secured to first bag 12 and in fluid communication with the chamber defined by first bag 12. Pressure relief valve 20 is set to ensure the burst pressure limit of first bag 12 is not exceeded. It further may be used to vent or purge air or other gases from first bag 12 when filling the bag with unfiltered fluids.

With first bag 12 filled and first bag inlet 14 closed via inlet plug 24, a soda-siphon-type cartridge/spigot (not shown) is inserted into soda siphon-type inlet valve port 22 manually or via a soda-siphon cartridge gun. Both the cartridge and cartridge gun are made from lightweight materials for portability purposes. The soda-siphon style cartridge also may be torqued into the soda-siphon-type inlet valve via mating threading on the cartridge and the inlet valve. Before activating the soda-siphon cartridge, the various manually-operated valves between the bags are opened to ensure fluid communication from first bag 12 to second bag 28. With the valves in the open position, (and the second bag outlet check valve and sip tube check valves in their closed positions), the soda-siphon cartridge is activated to infuse a high-pressure gas into the first bag chamber. The gas pressurizes the unpurified water to a pressure in excess of 60 psi to urge and facilitate the flow of unpurified water through reverse osmosis filter 44.

Water passing through reverse osmosis filter 44 will now be in a purified state before entering the clean water bag, second bag 28. The user will be alerted to the process being complete when second bag 28 has a bloated appearance that remains constant. The gas used to force the water through reverse osmosis filter 44 will not escape the contaminated water bag, first bag 12, and pass through the filter as the pressure of the gas is set to be below the bubble point of the reverse osmosis filter. When the purification process is complete, the pressure in the apparatus can be released via manual operation of pressure relief valve 20.

To access the purified water for drinking, the user simply inserts either second bag outlet 36 or flexible sip tube 40 into their mouth and applies suction to either tube to overcome the check valves to allow purified water to flow out of second bag 28 and into the user's mouth. Additionally, the purified water can be transferred to another container for storage and future use for drinking and cooking. Once emptied, water purification apparatus 10 can be folded for storage and future use. Any gas canister used to pressurize the system can simply be removed from the assembly and discarded

Reverse osmosis filter assembly 44 can be used multiple times before replacement is necessary. When the filter has reached its usable limit, the filter can simply be swapped out with a new filter via the quick connects. The filter can be selectively removed from linking hose 42 or the combination of the filter and hose can be removed as a unit and replaced as a unit with a new filter and hose assembly.

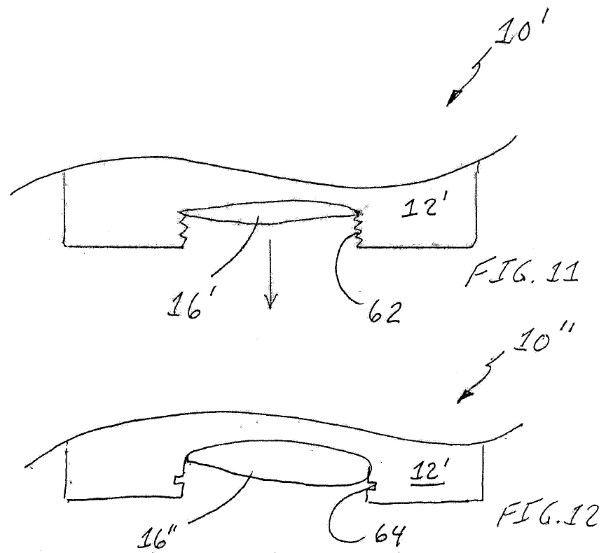

Referring now to FIG. 9, in another embodiment of the disclosure, water purification apparatus 10 is fitted with an adapter 60 secured to a pressurized-gas-receiving port in the form of a soda-siphon-type inlet valve port 22. This permits other gas sources, e.g., compressed air and inert gas cartridges, pressurized tire inflators and the like, to be used to generate pressure in the bag chamber. Adapter 60 will have two connection features. The first connection feature, e.g., threading, will be constructed for engagement and registration with the soda-siphon-type inlet valve port 22 connection features used to connect a soda-siphon cartridge or a soda-siphon cartridge gun. In the embodiment disclosed hereinabove, corresponding male and female threaded ports permit adaptor 60 to be secured to soda-siphon-type inlet valve port 22. An optional O-ring (not shown) or other sealing means may be used to create an air-tight seal between adapter 60 and soda-siphon-type inlet valve port 22.

The second connection will be constructed to receive the alternate pressurized gas source. This engagement means between the adapter and alternate gas source can be corresponding threaded surfaces, bayonet-style connectors, snap-fit, quick-connect connectors and the like. An optional O-ring or similar sealing means may be used to create or enhance an air-tight seal. With respect to the gases that may be used to pressurize first bag 12, inert gases, e.g., nitrogen and argon, may be used to avoid reactivity with any contaminants in the water being treated. It should be understood that other gases may be used and remain within the scope of the disclosure. Any cartridge or other container secured to adapter 60 may be discarded or refilled after use.

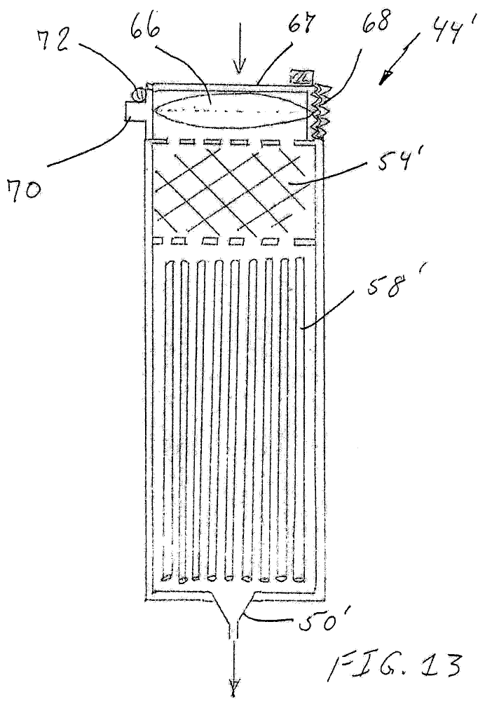

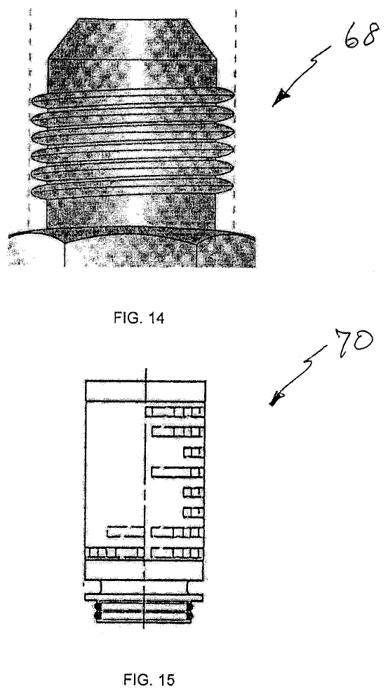

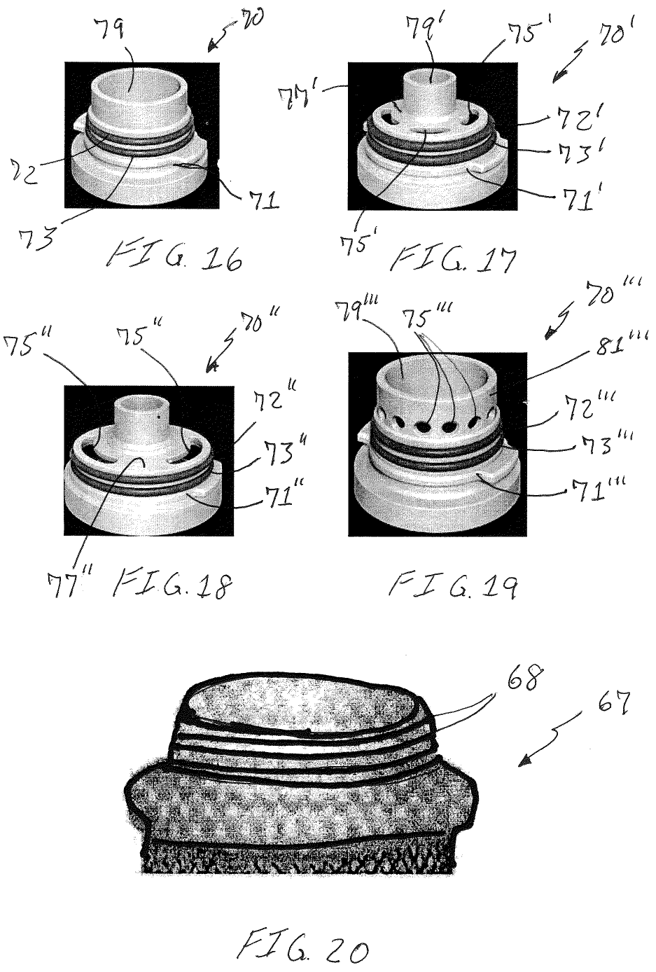

Referring now to FIGS. 10, 11 and 13, in another aspect of the disclosure, a water purification apparatus, designated generally as 10′ includes a single contaminated-water bag or bladder 12′ designated as a contaminated water bag. As used herein, identical reference characters having differently primed or unprimed variations, and assigned to features of the disclosure embodiments, are intended to identify different embodiments of the same feature. Bag 12′ is essentially a flexible, pliable and/or stretchable bag that can expand with the introduction of liquids and/or gases into a volumetrically modifiable bag chamber defined by the wall of bag 12′. Bag 12′ has a bag inlet 14′ extending from a top end of bag 12′ with optional internal (or external) threading to receive a bag inlet plug 24′ with optional external (or internal) threading spaced to match the spacing of the first bag inlet internal threading. In an alternate embodiment, inlet plug 24′ may be a tapered elastomeric plug that secures into bag inlet 14′ via a friction fit or an inlet plug with bayonet style engagement features. Bag inlet 14′ is in fluid communication with the bag chamber. It should be understood that the top end of bag 12′ is determined by the location of bag inlet 14′.

Bag 12′ further includes a bag outlet 16′ that extends from a bottom end of bag 12′. A bag outlet valve 18′ provides a means to open and close the outlet. An end of bag outlet 16′ may be formed as, or have secured thereto, a male or female quick disconnect 17′ for attachment to a hose disclosed in detail hereinbelow. It should be understood that outlet valve 18′ and quick connect 17′ can be a combination component. Bag outlet 16′ is in fluid communication with the bag chamber. Bag outlet valve 18′ is closed initially when filling bag 12′ with unfiltered water or other liquid.

Bag 12′ further includes a pressurized-gas-receiving port in the form of a soda-siphon-type inlet valve port 22′ secured to a top end of bag 12′. Like soda-siphon-type inlet valve port 22, soda-siphon-type inlet valve port 22′ is essentially a check valve that permits the attachment of a soda-siphon-type cartridge/spigot to introduce pressurized gas into the apparatus as disclosed in more detail herein. It should be understood that the location of soda-siphon-type inlet valve port 22′ is not limited to the top end of bag 12′ but may be positioned on any end or outer surface of bag 12′. Soda-siphon-type inlet valve port 22′ is in fluid communication with the bag chamber. A pressure relief valve 20′ is secured to bag 12′ and in fluid communication with the chamber defined by bag 12′. Pressure relief valve 20′ is set to ensure the burst pressure limit of bag 12′ is not exceeded and provides a means for air or other gases to escape, or be purged from, the chamber when bag 12′ is filled with untreated liquids.

In this embodiment, like water purification apparatus 10, water purification apparatus 10′ may be fitted with an adapter 60′ secured to soda-siphon-type inlet valve port 22′. This permits other gas sources, e.g., compressed air and inert gases, pressurized tire inflators and the like, to be used to generate pressure in the bag chamber. Adapter 60′ will have two connection features. The first connection feature, e.g., threading, will be constructed for engagement and registration with the soda-siphon-type inlet valve port 22′ connection features used to connect a soda-siphon cartridge or a soda-siphon cartridge gun. In the embodiment disclosed hereinabove, corresponding male and female threaded ports permit adaptor 60′ to be secured to soda-siphon-type inlet valve port 22′. An optional O-ring (not shown) or other sealing means may be used to create an air-tight seal between adapter 60′ and soda-siphon-Type inlet valve port 22′.

The second connection will be constructed to receive the alternate pressurized gas source. This engagement means between the adapter and alternate gas source can be corresponding threaded surfaces, bayonet-style connectors, snap-fit, quick-connect connectors and the like. An optional O-ring or similar sealing means may be used to create or enhance an air-tight seal. With respect to the gases that may be used to pressurize contaminated water bag 12′, inert gases, e.g., nitrogen and argon, may be used to avoid reactivity with any contaminants in the water being treated. It should be understood that other gases may be used and remain within the scope of the disclosure. Any cartridge or other container secured to adapter 60′ may be discarded or refilled after use.

An optional linking hose 42′ may be used to connect contaminated water bag 12′ to a filtration apparatus assembly, designated generally as 44′, described in detail hereinbelow. Linking hose 42′ is structured to be flexible with a first hose male or female quick connect 43′ formed on, or attached to a first hose end 45′ that attaches to quick connect 17′ of contaminated water bag outlet 16′. A second hose male or female quick connect 47′ formed on, or attached to, a second hose end 49′ attaches to filtration apparatus assembly 44′.

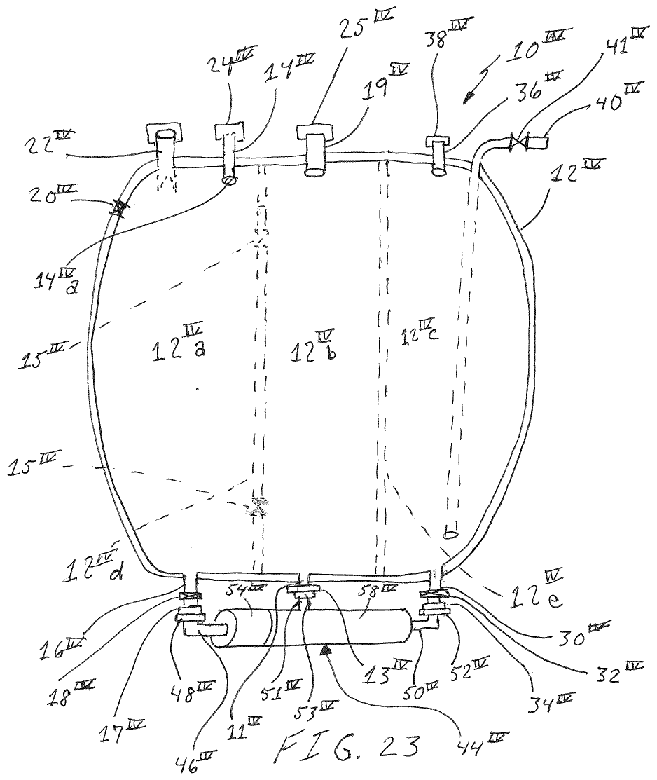

In a yet further alternative embodiment, outlet 16′ is formed with threading 62 to receive corresponding threading 68, (shown in FIG. 20), on filtration apparatus inlet 67. This permits filtration apparatus assembly 44′ to be torqued onto outlet 16′ and receive contaminated water from the contaminated water bag. In a yet further alternative embodiment, a water purification apparatus, designated generally as 10″ (shown in FIG. 12) has an outlet 16″ formed with a helical bayonet-style slot 64 to receive a corresponding helical bayonet-style ridge 71 of a bayonet-style connector 70 (shown in FIG. 16). This also permits filtration apparatus assembly 44′ to be torqued onto outlet 16″ and receive contaminated water from the contaminated water bag. An optional O-ring 72 may be used to create a fluid-tight seal between the contaminated water bag outlet and the filtration apparatus inlet. A second O-ring 73 also may be used to further bolster the fluid-tight seal.

FIGS. 17-19 show additional bayonet-style connectors. A bayonet-style end-cap connector 70′ (shown in FIG. 17), includes a bayonet-style ridge 71′ with a first O-ring 72′ and a second O-ring 73′. Crescent-shaped apertures 75′ formed in a shoulder 77′ provide alternative routes for fluid flow from the bag/bladder into a filtration apparatus assembly, described in detail below. Although bayonet-style connector 70′ is designed to promote central flow through the main bore 79′ of the connection end-cap connector, if the portion of the end-cap connector that pushes open a diaphragm valve in a corresponding connector, and the diaphragm valve is not castled and instead solid, crescent-shaped apertures 75′ permits fluid flow when main bore 79′ is blocked.

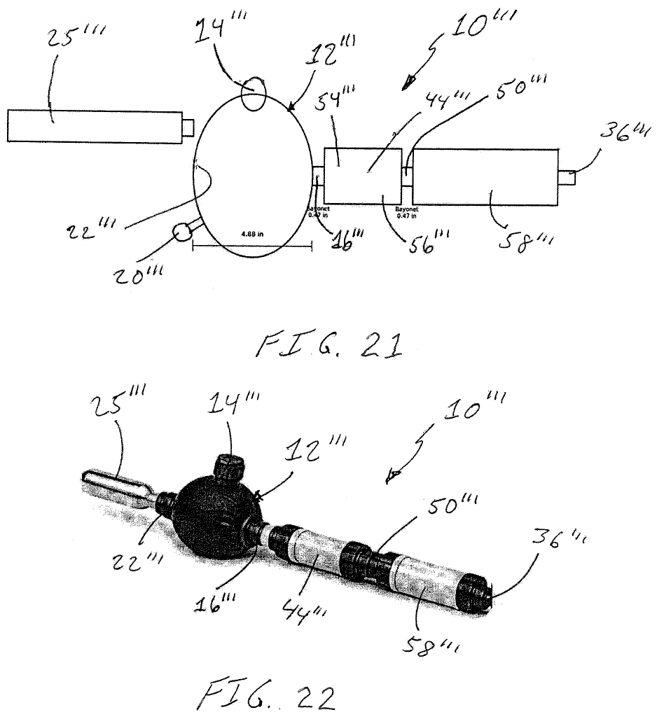

Referring now to FIG. 18, a bayonet-style end-cap connector 70″ has essentially the same features as bayonet-style end-cap connector 70′. Connector 70″ has a main bore 79′, and a bayonet-style ridge 71″ with a first O-ring 72″ and a second O-ring 73″. A plurality of crescent-shaped apertures 75″ formed in a shoulder 77″ are dimensioned to be larger than the crescent-shaped apertures 75′ of end-cap connector 70′ and also provide alternative routes for fluid flow from the bag/bladder into a filtration apparatus assembly, described in detail below.

Referring now to FIG. 19, a bayonet-style end-cap connector 70′″ has essentially the same features as bayonet-style end-cap connector 70′. Connector 70′″ has a main bore 79′″, and a bayonet-style ridge 71′″ with a first O-ring 72′″ and a second O-ring 73′″. A plurality of circular apertures 75′″ are formed in a vertical cylindrical end-cap connector wall 81′″ to provide alternative routes for fluid flow from the bag/bladder into a filtration apparatus assembly, described in detail below.

Secured either in-line with linking hose 42′ or directly to either water treatment apparatus 10′ and/or water purification apparatus 10″ is filtration apparatus assembly 44′ as shown in FIG. 13. Filtration apparatus assembly 44′ has an outlet 50′. Whether a single or multi-stage filtration apparatus, all stages of filtration are contained in a single filtration apparatus assembly cartridge having male/female orientations of inlet and outlet connectors that prevent the cartridge from being assembled in the incorrect direction of water flow.

### Filtration Apparatus Assembly 44′ Is in a Capsule or Cartridge Form With at

least two distinct sections. A deflector 66 is positioned adjacent and downstream from filtration apparatus assembly inlet 67 to evenly disperse the incoming contaminated liquid about the top of a first pre-filtration section that contains a depth filter 54′ formed with pore sizes and a porosity configured to capture silt, large particulate matter and bulk debris. Reverse osmosis filter assembly 44′ also may include a retentate bleed valve 53′ to permit the release of retentate during a filtration procedure. If bleed valve 53′ is present, to encourage preferential flow through the reverse osmosis membrane, bleed valve 53′ has a constricted internal diameter that creates back pressure. This filter is constructed illustratively from materials that are fibrous and non-woven. Illustrative examples are glass fiber, polypropylene and polyester and other materials commonly known in the art for constructing depth filters. A second section is a reverse osmosis filter 58′ that will capture and retain any remaining nuclear, biological and chemical contaminants. As stated above, common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors.

To operate either water purification apparatus 10′ or 10″, unpurified water is collected into the contaminated water bag, contaminated water bag 12′. In this initial step, any manually-operated valves are placed in the closed position (other than pressure-relief valve 20′. Threaded plug 24′ is unscrewed from bag inlet 14′ to permit unpurified water to be poured into the inlet, which may have a diameter of approximately one inch. It should be understood that the diameter of the inlet can be set to any dimension and remain within the scope of the disclosure. Once contaminated water bag 12′ has been filled, threaded plug 24′ is secured back into first bag inlet 14′. Contaminated water bag 12′ is constructed to have high burst pressure tolerances as disclosed in more detail hereinabove. Pressure relief valve 20′ is set to ensure the burst pressure limit of contaminated water bag 12′ is not exceeded.

With contaminated water bag 12′ filled, a soda-siphon-type cartridge (not shown) is inserted into soda siphon-type inlet valve port 22′ manually or via a soda-siphon cartridge gun. Both the cartridge and cartridge gun are made from lightweight materials for portability purposes. The soda-siphon style cartridge also may be torqued into the soda-siphon-type inlet valve via mating threading on the cartridge and the inlet valve. Before activating the soda-siphon cartridge, the various manually-operated valves are opened to ensure fluid communication from contaminated water bag 12′ to filtration apparatus assembly 44′. With the valves in the open position, the soda-siphon cartridge is activated to infuse a high-pressure gas into the contaminated water bag chamber. The gas pressurizes the unpurified water to a pressure in excess of 60 psi to urge and facilitate the flow of unpurified water through reverse osmosis filter 58′.

Water passing through reverse osmosis filter 58′ will now be in a purified state before exiting filtration apparatus assembly 44′. The gas used to force the water through reverse osmosis filter 58′ will not escape the contaminated water bag 12′ and pass through the filter as the pressure of the gas is set to be below the bubble point of the reverse osmosis filter 58′. When the purification process is complete, the pressure in the apparatus can be released via manual operation of pressure relief valve 20′.

To access the purified water for drinking, the user simply places a liquid containment vessel under filtration apparatus assembly outlet 50′. If valved, the purified liquid will simply flow out of outlet 50′ with the valve in an open position, (the valve position necessary to perform the water purification process. Additionally, the purified water can be drunk directly from outlet 50′ or transferred to another container for storage and future use for drinking and cooking. Once emptied, water purification apparatus 10′ or 10″ can be folded for storage and future use.

Filtration apparatus assembly 44′ can be used multiple times before replacement. When the filter has reached its usable limit, the filter can simply be swapped out with a new filter via the quick connects or other disclosed connection features. The filter can be selectively removed from linking hose 42′ or the combination of the filter and hose can be removed as a unit and replaced as a unit with a new filter and hose assembly.

Volumetrically, the volume of the contaminated water bag 12′ can be set to any number of volumes as described for water purification apparatus 10. Again, by way of illustration and not limitation, the bag volumes can be set at 250 ml, 500 ml, one liter, 4 liters, etc., and remain within the scope of the disclosure. The burst pressure of contaminated water bag 12′ can be set at approximately 150 psi. It should be understood that the bag material used and the pressure ratings achieved can vary and remain within the scope of the disclosure. Contaminated-water bag 12′ can have a lightweight nylon, wire or polymeric net superposed about the bag to provide added structural support to counter the internal pressures. Suitable materials for the bag include illustratively, Polyurethane, Thermoplastic Polyurethane (TPU), Acrylonitrile Butadiene Styrene (ABS), Silicone, Polyoxymethylene, Ethylene Propylene Diene Monomer Rubber (EPDM) and combinations thereof.

Referring now to FIGS. 18 and 19, in another aspect of the disclosure, a water purification apparatus, designated generally as 10′″ includes a single contaminated-water bag or bladder 12′″ designated as a contaminated water bag. Like bag 12′, bag 12′″ is essentially a flexible, pliable and/or stretchable bag that can expand with the introduction of liquids and/or gases into a volumetrically modifiable bag chamber defined by the wall of bag 12′″. It should be understood that the three-dimensional geometric configuration of bag 12′″ as well as any bag/bladder disclosed herein, can be formed as a sphere, oval, rectangle, square or any regular or irregular two or three-dimensional geometric shape and remain within the scope of the disclosure. To ensure uniform pressure is applied to all the inner surfaces of bag 12′″, a spherical or oval shape should enable the application of uniform pressure to all of the bag inner surface when under pressure.

Other components of filtration apparatus 10′″ include a compressed air cartridge 25′″, an air inlet bayonet interface port 22′″, an untreated or raw water inlet port 14′″, a dual-stage prefilter 44′″, a reverse osmosis filter module 58′″, a reverse osmosis outlet interface 36′″ and a receiver coupler with valve and vent 20′″. Each of these components will be described in detail herein. It should be understood that each of these components are described illustratively and may be formed with different configurations and/or dimensions and remain within the scope of the disclosure.

Compressed air cartridge 25′″ stores compressed air and/or inert gas to provide pressure to urge water contained in contamination bag 12′″ into the downstream filter components. If compressed air is not available, inert gases that may be used in substitution of air include illustratively, argon, helium, krypton, neon, nitrogen and xenon. Carbon Dioxide is another potential substitution gas although this gas is likely a last resort as it is soluble in water and can form carbonic acid when mixed with water. It should be understood that these gases are disclosed purely as alternatives to the preferred compressed air, which will not react with the water component of untreated water. It should be understood further that any of the gases disclosed here may be used with any of the water purification apparatus embodiments disclosed herein.

Illustrative, non-limiting compressed air cartridge specifications include the following. The cartridges may be formed from carbon/epoxy tubing, 7075-T6 hard anodized bayonet nose with a silicone EPDM O-ring seal. The cylinder size may be approximately 42 mm wide×150 to 160 mm long. The internal volume may be 0.156 liters free gas volume at 100 psi absolute. The empty mass may be about 35 to about 55 grams.

In a yet alternative embodiment, a pressurized-gas-receiving port in the form of a Schrader valve port 22′″ is secured to the contaminated water bag, e.g., bag 12′″ and first bag chamber 12^{IV} (disclosed below), to permit conventional compressed air sources, e.g., compressed air/nitrogen to fill automobile tires, to be used to pressurize the contaminated water chamber/bag. This expands the adaptability of the water purification apparatuses disclosed herein to use other sources of readily available compress's air/gases to perform the filtration and water purification function.

Bag 12′″ has a bag inlet port 14′″ extending from a top end of bag 12′″ with optional internal (or external) threading to receive a bag inlet plug (not shown) with optional external (or internal) threading spaced to match the spacing of the bag inlet internal threading. In an alternate embodiment, the inlet plug may be a tapered elastomeric plug that secures into bag inlet 14′″ via a friction fit or an inlet plug with bayonet style engagement features. Bag inlet 14′″ may have a 1-inch inner diameter and may include a particle-trapping sieve (not shown) to prevent large particulates from entering the bag chamber. It should be understood that the diameter of the inlet can be set to any dimension and remain within the scope of the disclosure. Bag inlet 14′″ is in fluid communication with the bag chamber. It should be understood further that the top end of bag 12′″ is determined by the location of bag inlet 14′. Untreated water is allowed to flow into bag 12′″ via gravity feed or via an external pump, automated or manually operated.

Illustrative, non-limiting bag specifications include the following. The volumetric capacity may be set at 1 liter. The pressure rating may be set at 200 psi absolute (gas). The inflated form may be spherical at approximately 124 mm or 4.88 inches in diameter. The bladder may be formed from a TPU-coated aramid fabric, TPU resin system NSF/ANSI 61 certified. The seams may be RF welded/heat sealed. Any openings in the bladder may be sealed with silicone O-rings (FDA 32 C.F.R. § 177.2600 compliant compound). The inlet port/boss may be constructed from 7075-T6 anodized aluminum with a reinforcement patch stack. The bag mass may be from about 29 to about 40 grams empty.

Returning to the bag structure, bag 12′″ further includes a bag outlet 16′″ that extends from a side of bag 12′″. A downstream end of bag outlet 16′″ is secured to an upstream end of dual-stage prefilter 44′″. An end of bag outlet 16′″ may be formed as, or have secured thereto, a male or female quick disconnect 17′″ for attachment to a corresponding female or male quick disconnect secured to the upstream end of dual-stage prefilter 44′″. Bag outlet 16′″ is in fluid communication with the bag chamber and in fluid communication with an internal chamber of dual-stage prefilter 44′″.

A pressurized-gas-receiving port in the form of an air inlet bayonet interface port 22′″ is secured, off-axis, to a side end of bag 12′″ that may be opposite the side end to which bag outlet 16′″ is secured. Air inlet bayonet interface port 22′″ provides a means to rapidly secure compressed air cartridge 25′″ with a quarter turn, which permits the controlled blowdown of the compressed air in the cartridge before ultimate removal from bag 12′″. Air inlet bayonet interface port 22′″ also permits the rapid removal of compressed air cartridge 25′″ so as to initiate another round of water purification. It should be understood that the location of air inlet bayonet interface port 22′″ is not limited to the side of bag 12′″ but may be positioned on any end or outer surface of bag 12′″. Air inlet bayonet interface port 22′″ is in fluid communication with the bag chamber. It should be understood that the bayonet-style connection is described illustratively, and not by way of limitation. Other connection means, e.g., threaded surfaces, may be used to secure compressed air cartridge 25′″ to air inlet bayonet interface port 22′″ and remain within the scope of the disclosure. An optional O-ring (not shown) or other sealing means may be used to create an air-tight seal between compressed air cartridge 25′″ and air inlet bayonet interface port 22′″.

As disclosed above, bag outlet 16′″ connects to dual-stage prefilter 44′″, downstream from bag 16′″, that provides the initial filtration processes. Dual-stage prefilter 44′″ is in a capsule or cartridge form with at least two distinct sections. A top section, a particulate reduction section, contains a depth filter 54′″ formed with pore sizes and a porosity configured to capture silt, large particulate matter and bulk debris. This section of the prefilter effectively removes suspended solids and turbidity from the raw untreated water. This depth filter is constructed illustratively from materials that are fibrous and non-woven. Illustrative examples are glass fiber, polypropylene and polyester and other materials commonly known in the art for constructing depth filters.

A second or bottom section of the dual-stage prefilter is an activated carbon section 56′″ that contains activated carbon to capture and retain any organic matter and organic chemical contaminants in the water being purified. This section further reduces chlorine, tase and odor. This section, positioned upstream the reverse osmosis section 58′″, protects the reverse osmosis membrane from damage that can be brought about by exposure to particulate matter. Dual-stage prefilter 44′″ has an outlet 50′″ with connection means, e.g., bayonet-style features, threaded features, etc., that permit connection to an inlet of reverse osmosis filter module 58′″ that has corresponding connection means as described in more detail hereinabove. Whether dual-stage prefilter 44′″ is a single or multi-stage filtration apparatus, all stages of prefiltration are contained in a single filtration apparatus assembly cartridge having male/female orientations of inlet and outlet connectors that prevent the cartridge from being assembled in the incorrect direction of water flow.

Reverse osmosis filter module 58′″, also in cartridge form, will capture and retain any remaining nuclear, biological and chemical contaminants including dissolved salts, heavy metals, pathogens, and low-molecular weight chemical contaminants. More particularly, as stated above, common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors.

Reverse osmosis outlet interface 36′″ that extends from a downstream end of reverse osmosis filter module 58′″ may be in the form of a hose-barb outlet that permits the delivery of purified water directly to one's mouth or other water holding apparatus, e.g., canteen, cup, and/or hydration system. Additional details of reverse osmosis outlet interface 36′″ are described below.

Receiver coupler with valve and vent 20′″ is secured to bag 12′″ and in fluid communication with the chamber defined by bag 12′″. Receiver coupler with vale and vent 20′″ controls pressurization, depressurization, and safe connect/disconnect conditions under ambient or other environmental conditions. The coupler is set to ensure the burst pressure limit of bag 12′″ is not exceeded and provides a means for air or other gases to escape, or be purged from, the chamber when bag 12′″ is filled with untreated liquids or after a filtration process has been completed.

Illustrative, non-limiting receiver coupler with vent and valve specifications include the following. The coupler may be made from a hard anodized aluminum body with a polymer poppet (POM or PEEK), a stainless-steel spring and silicone/EPDM seals. The bayonet socket envelope may be from about 25 to about 35 mm wide, (dependent upon mounting and integration).

Illustrative, non-limiting size and weight parameters include the following. The overall weight may be about 340 grams (12 oz.). The component mass breakdown is as follows. The reverse osmosis filter module may be about 210 grams (7.40 oz.). The dual-stage prefilter may be about 55 grams (1.94 oz.) that includes the carbon and particulate components. The compressed air bladder (empty) is about 35 grams (1.23 oz.). The receiver coupler and interface is about 40 grams (1.41 oz.). It should be noted that these weight parameters do not include the mass of water and/or any compressed air mass.

To operate water purification apparatus 10′″, unpurified water is collected into contaminated water bag 12′″. Threaded plug 24′″, if present, is unscrewed from bag inlet 14′″ to permit unpurified water to be poured into the inlet. Once contaminated water bag 12′″ has been filled, threaded plug 24′″, if present, is secured back into bag inlet 14′″.

With contaminated water bag 12′″ filled, compressed air cartridge 25′″ is secured to air inlet bayonet interface port 22′″. This punctures the outlet end of the cartridge that results rapid transmission of the contained pressurized air/gas into the bag chamber that forces untreated water contained in contaminated bag 12′″ into dual stage prefilter 44′″. The gas pressurizes the unpurified water to a pressure in excess of 60 psi to urge and facilitate the flow of unpurified water through both dual-stage prefilter 44′″ and reverse osmosis filter module 58′″ so as to deliver purified water to reverse osmosis interface 50′″ for immediate consumption. By utilizing this layered approach to water filtration, broad-spectrum purification is achieved without the need for consumable chemicals. This discrete-stage architecture enables the prefilter to be sacrificial, thereby reducing fouling of the downstream reverse osmosis filter module and supports repeated use of the reverse osmosis filter module.

Water passing through reverse osmosis filter module 58′″ will now be in a purified state before exiting the module. The gas used to force the water through reverse osmosis filter module 58′″ will not escape contaminated water bag 12′″ and pass through the filter as the pressure of the gas is set to be below the bubble point of the reverse osmosis filter 58′″. When the purification process is complete, the pressure in the apparatus can be released via manual or preset operation of receiver coupler with vent and valve 20′″.

To access the purified water for drinking, the user simply places a liquid containment vessel under reverse osmosis interface 50′″. If valved, the purified liquid will simply flow out of interface/outlet 50′″ with the valve in an open position, (the valve position necessary to perform the water purification process if such a valve is present). Additionally, the purified water can be drunk directly from outlet/interface 50′″ or transferred to another container for storage and future use for drinking and cooking. Once emptied, water purification apparatus 10′″ can be depressurized for storage and future use.

Illustrative, non-limiting performance specifications include the following. For the reverse osmosis filter module, the permeate flow rate is about 250 ml/min. (approximately 4 minutes per liter). The feed pressure is about 100 psi (about 6.9 bar). The operating temperature is expected to be ambient, from about 1° to about 45° C. The use expectation is repeated cycles. And the rated capacity is from about 75 to about 100 GPD at 60 psi. At 100 psi, 250 ml/min. should be well within normal operating expectations.

Both the dual-stage prefilter 44′″ and reverse osmosis filter module 58′″ can be used multiple times before replacement. When the filters have reached their usable limit, the filters can simply be swapped out with new filters via the quick connects or other disclosed connection features. The filters can be selectively removed from the apparatus or removed as a unit and replaced as a unit.

Volumetrically, the volume of the contaminated water bag 12′″ can be set to any number of volumes as described for water purification apparatus 10. Again, by way of illustration and not limitation, the bag volumes can be set at 250 ml, 500 ml, one liter, 4 liters, etc., and remain within the scope of the disclosure. Compressed air and/or compressed inert gases provide the energy source that urges untreated water through the filtration apparatus. No other energy source, e.g., electricity, vacuum pressure, or any chemical treatment is needed to perform the water purification function. The burst pressure of contaminated water bag 12′″ can be set at approximately 150 psi and can range illustratively from about 100-200 psi (6.9 bar and up). The operating temperature may be between about 20° C. and about 25° C. As explained herein, the filter apparatuses may be used repeatedly and have a rated capacity of about 75 to about 100 gallons per day (GPD) at 60 psi depending upon the Silt Density Index of raw water, which is a measure of the level of particulates present in raw water. At 100 psi, 250 ml/min. is well within the normal operating expectations. It should be understood that the pressure ratings achieved can vary beyond the stated range(s) and remain within the scope of the disclosure.

It is expected that filter apparatus 10′″, as well as any of the other filter apparatus embodiments disclosed herein, can purify one liter of water within approximately 4 minutes. This standalone apparatus can be adapted for direct attachment to a MOLLE hydration system and is designed to bring, freshwater, salt water, urine and other forms of contaminated water to a potable standard of use in compliance with NSF P248.02-2025. In meeting this standard, filter apparatus 10′″, as well as the other disclosed filter apparatuses, reduces and/or eliminates the presence of particulates, chlorine, inorganic, organic and certain elemental chemicals, dissolved salts, and pathogenic organic materials/organisms.

Like bag 12′, contaminated-water bag 12″ can have a lightweight nylon, wire or polymeric net superposed about the bag to provide added structural support to counter the internal pressures. Suitable materials for the bag include illustratively, Polyurethane, Thermoplastic Polyurethane (TPU), Acrylonitrile Butadiene Styrene (ABS), Silicone, Polyoxymethylene, Ethylene Propylene Diene Monomer Rubber (EPDM) and combinations thereof.

The bags may be carried in a compact manner on or in a backpack, one folded against the other. When needed to purify water, the water purification apparatus bags are removed from the shoulder or the backpack and unfolded. All stages of filtration are contained in two separate or a single filter cartridge equipped with either a quick connect male inlet and a quick connect female outlet or with the other connection features disclosed herein. The male/female orientations of the inlets and outlets prevent the filter cartridge(s) from being assembled in the incorrect direction of water flow.

### Referring Now to FIGS. 23 and 29, in Another Aspect of the Disclosure, a

water purification apparatus, designated generally as 10^{IV}, differs from the prior described “Dead End” embodiments, water purification apparatuses 10 and 10′, that include a filtration assembly positioned at the extreme downstream end of the entire apparatus. In contrast, water purification apparatus 10^{IV} includes a tri-chamber bag or tri-chamber bladder 12^{IV} having a first bag chamber 12^{IV}a designated as a contaminated water chamber defined by the outer wall of tri-chamber bag 12^{IV} and a first chamber partition wall 12^{IV}d. A second bag chamber 12^{IV}b is designated as a retentate chamber defined by the outer wall of tri-chamber bag 12^{IV}, first chamber partition wall 12^{IV}d and a second chamber partition wall 12^{Iv}e. A third bag chamber 12^{IV}c is designated as a purified water chamber defined by the outer wall of tri-chamber bag 12^{IV} and second chamber partition wall 12^{IV}e. Each chamber is attached to a reverse osmosis cartridge in a cross-flow filtration mode to maximize the volume of potable water produced per unit volume of raw water transferred into the apparatus.

Tri-chamber bag 12^{IV} is essentially a flexible, pliable and/or stretchable bag that can expand with the introduction of liquids and/or gases into a volumetrically modifiable bag. First bag chamber 12^{IV}a has a raw water inlet port 14^{IV} extending from a top or upstream end of tri-chamber bag 12^{IV} with optional internal or external threading to receive a first chamber inlet plug or cap 24^{IV} with optional external or internal threading dimensioned and spaced to match the dimensions and spacing of the first bag inlet internal or external threading. In an alternate embodiment, inlet plug or cap 24^{IV} may be a tapered elastomeric plug that secures into raw water inlet port 14^{IV} via a friction fit or a plug with bayonet-style engagement features. Raw water inlet port 14^{IV} is in fluid communication with first bag chamber 12^{IV}a and may be used to collect water. A first chamber inlet port screen 14^{IV}a may be secured to a bottom end of raw water inlet port 14^{IV} to filter out particulate matter if the port is used to collect water from any natural or man-made water-containing source such as a reservoir. The port's distal end may be enlarged to improve water capture. It should be understood that for orientation purposes, the top end of tri-chamber bag 12^{IV} is determined by the location of raw water inlet port 14^{IV}.

First bag chamber 12^{IV}a further includes a first bag chamber outlet port 16^{IV} that extends from a bottom end of tri-chamber bag 12^{IV}. A first bag chamber outlet valve 18^{IV} secured to a distal end of first bag chamber outlet port 16^{IV} provides a means to open and close the outlet. A distal end of first bag chamber outlet port 16^{IV} may be formed as, or have secured thereto, a first bag chamber outlet port quick disconnect 17^{IV} may be either a male or female end of a quick disconnect for attachment to a hose or tube with the corresponding female or male quick disconnect secured to an inlet port of a reverse osmosis assembly disclosed in detail hereinbelow. It should be understood that outlet valve 18^{IV} and first bag chamber outlet port quick disconnect 17^{IV} can be a combination component. First bag chamber outlet port 16^{IV} is in fluid communication with first bag chamber 12^{IV}a. First bag chamber outlet valve 18^{IV} is closed initially when filling first bag chamber 12^{IV}a with unfiltered raw water or other liquid. If a combination quick disconnect and shut-off valve is used, connection of the male and female components of the quick disconnect will open the shut-off valve. Conversely, disconnection of the quick disconnect components will close the shut-off valve to ensure liquids in first bag chamber 12^{IV}a will be retained in the chamber.

Tri-chamber bag 12^{IV} further includes a pressurized-gas-receiving port in the form of a soda-siphon-type inlet and valve assembly port 22^{IV} secured to a top end of tri-chamber bag 12^{IV}. Soda-siphon-type inlet and valve assembly port 22^{IV} is essentially a check valve that permits the attachment of a soda-siphon-type cartridge/spigot to introduce pressurized gas into the apparatus as disclosed in more detail herein. It should be understood that the location of soda-siphon-type inlet and valve assembly port 22^{IV} is not limited to the top end of tri-chamber bag 12^{IV} but may be positioned on any end or outer surface of tri-chamber bag 12^{IV}. Soda-siphon-type inlet valve port 22^{IV} is in fluid communication with first bag chamber 12^{IV}a.

Second bag chamber 12^{IV}b has a series of ports, each of which is assigned a specific function. A second bag chamber inlet port 11^{IV} is positioned at a bottom end of second bag chamber 12^{IV}b, which represents the upstream end of the second bag chamber when a filtration function is performed. Second bag chamber inlet port 11^{IV} is in fluid communication with second bag chamber 12^{IV}b and provides an inlet for retentate produced by a reverse osmosis filter as described in more detail herein. A distal end of second bag chamber inlet port 11^{IV} is formed with, or has attached thereto, a second bag chamber quick disconnect and shut-off valve 13^{IV}. It should be understood that the quick disconnect and valve can be two separate devices. If separate, a separate shut-off valve has to be operated manually. As is well known in the art, there is a female component and a male component to a quick disconnect. Either component can be secured to second bag chamber inlet port 11^{IV} with the corresponding component connected to a retentate port of a reverse osmosis filter as disclosed in more detail herein. By design, by connecting the two components of the quick disconnect causes the shut-off valve to open. By disconnecting the two components, the shut-off valve will close and prevent any leakage of liquids or gases out of second bag chamber 12^{IV}b.

At least one cross-chamber valve 15^{IV} is formed in first chamber partition wall 12^{IV}d and provides a travel path for retentate to flow back into first bag chamber 12^{IV}a for further filtration. By design, cross-chamber valve 15^{IV} is a one-way valve, such as a check valve, to permit liquids within second bag chamber 12^{IV}b to only flow into first bag chamber 12^{IV}a. A pressure gradient formed between second bag chamber 12^{IV}b and first bag chamber 12^{IV}a, with the higher pressure in the second bag chamber, will open cross-chamber valve 15^{IV}. By using a one-way valve, any pressurization of first bag chamber 12^{IV}a during a filtration event will not allow raw water to flow into second bag chamber 12^{IV}b and only flow out of first bag chamber outlet port 16^{IV}. It should be understood that more than one cross-chamber valve 15^{IV} may be positioned at various locations along chamber partition wall 12^{IV}d to increase the volume flow between the two chambers.

Second bag chamber 12^{IV}b further includes a second bag chamber outlet port 19^{IV} positioned at a top end of tri-chamber bag 12^{IV}. Second bag chamber outlet port 19^{IV} is in fluid communication with second bag chamber 12^{IV}b and provides a means to drain any retentate remaining in the second bag chamber after a filtration event. This can be done also to lighten the load being carried by the user if retention of the retentate for future filtration is not necessary. For example, if raw water is readily available along an excursion, a user can discard or discharge the retentate.

Second bag chamber outlet port 19^{IV} can have optional internal or external threading to receive a second bag chamber inlet plug or cap 25^{IV} with optional external or internal threading dimensioned and spaced to match the dimensions and spacing of the second bag chamber outlet port internal or external threading. In an alternate embodiment, second bag chamber inlet plug 25^{IV} may be a tapered elastomeric plug that secures into second bag chamber outlet port 19^{IV} via a friction fit or a plug with bayonet-style engagement features.

Third bag chamber 12^{IV}c includes several ports. A third chamber bag inlet port 30^{IV} extending from a bottom end of tri-chamber bag 12^{IV} with a third bag chamber inlet shut-off valve 32^{IV} and a third bag chamber inlet male or female quick disconnect 34^{IV} formed on, or attached thereto. Third bag chamber inlet 30^{IV} is in fluid communication with the third bag chamber 12^{IV}c. As with other inlet valves disclosed herein, a combination quick disconnect and shut-off valve can be used in place of separate quick disconnect and shut-off valve devices. If separate devices are used, each has to be operated separately. If the combination is used, disengagement or engagement of the quick-disconnect will close or open the shut-off valve, respectively.

Third bag chamber 12^{IV}c further includes a third bag chamber outlet port 36^{IV} that extends from a top end of third bag chamber 12^{IV}c is in fluid communication with the third bag chamber. Third bag chamber outlet port 36^{IV} may have internal or external threading to receive a third bag chamber outlet port cap 38^{IV} having external or internal threading corresponding to the threading of the outlet port. Third bag chamber outlet port 36^{IV} provides a means to extract filtered, potable water from the third bag chamber as either a drinking port or as an attachment point for other secondary water extraction delivery or storage devices. Third bag chamber outlet port 36^{IV} is closed initially when filling first bag chamber 12^{IV}a with unfiltered water or other liquid. A gas vent and valve assembly (not shown) may be secured to third bag chamber 12^{IV} to permit the purging of air or other gases and/or liquids when third bag chamber 12^{IV} is receiving filtered liquid from a reverse osmosis filter as described in more detail hereinbelow.

Also extending from a top end of tri-chamber bag 12^{IV} is an optional flexible sip tube 40^{IV}. A sip tube valve 41^{IV} in the form of a check valve permits one-way transfer of purified water out of third bag chamber 12^{IV}c via sip tube 40^{IV}. When suction pressure is not applied, sip tube valve 41^{IV} prevents water within the third bag chamber from leaking out. A distal end of sip tube 40^{IV} can extend within third bag chamber 12^{IV}c proximal to a bottom of the chamber to enable most of the purified water to be sucked out of the bag via sip tube 40^{IV}. Alternatively, the outlet port for drinking water may be at the base of bag 12^{IV}c with an external flexible sip hose not shown in the drawing.

Secured to the three ports extending from the bottom end of tri-chamber bag 12^{IV} is a reverse osmosis filter assembly, designated generally as 44^{IV}. Reverse osmosis filter assembly 44^{IV} can be permanently affixed to the ports or secured thereto with the quick connect assemblies secured to the ports as disclosed hereinabove. In one embodiment, reverse osmosis filter assembly 44^{IV} has a reverse osmosis inlet port 46^{IV} with a first filter quick disconnect 48^{IV} that is either the male or female quick disconnect end that corresponds to the female or male first bag chamber outlet port quick disconnect 17^{IV}. Connection of the corresponding quick disconnect ends connects first bag outlet port 16^{IV} to reverse osmosis inlet port 46^{IV} to render first bag chamber 12^{IV}a to be in fluid communication with the internal chambers of reverse osmosis filter assembly 44^{IV}.

Reverse osmosis filter assembly 44^{IV} further has a reverse osmosis outlet port 50^{IV} with a second filter quick disconnect 52^{IV}. Second filter quick disconnect 52^{IV} can be either a male or a female quick disconnect connector end to correspond to the male or female version of third bag chamber quick disconnect 34^{IV}. With the corresponding quick disconnect ends connected, reverse osmosis outlet 50^{IV} and third bag chamber inlet port 30^{IV} will be in fluid communication with each other as well as with third bag chamber 12^{IV}c and the internal area of reverse osmosis assembly 44^{IV}. In one embodiment, all stages of filtration are contained in a single filter cartridge/assembly equipped with a quick disconnect male inlet and a quick disconnect female outlet with a corresponding female quick disconnect first bag chamber outlet and a male quick disconnect third bag chamber inlet. The male/female orientations of the reverse osmosis filter assembly inlet and outlet prevent the cartridge from being assembled in the incorrect direction of water flow.

Reverse osmosis filter assembly 44^{IV} has a third reverse osmosis retentate port 51^{IV} that extends from a side wall of the filter assembly at a point between the two ends of the filter assembly. Third reverse osmosis retentate port 51^{IV} provides an exit point for retentate captured by a reverse osmosis filter secured in reverse osmosis filter assembly 44^{IV}. A third reverse osmosis retentate port quick disconnect 53^{IV} is secured to an end of third reverse osmosis retentate port 51^{IV} and may be either a male or a female quick disconnect connector end to correspond to the male or female version of second bag chamber quick disconnect and shut-off valve 13^{IV}. Connection of the corresponding quick disconnect components will render second bag chamber 12^{IV}b to be in fluid communication with the internal area of reverse osmosis filter assembly 44^{IV}.

Reverse osmosis filter assembly 44^{IV} is in a capsule or in a cartridge form with two distinct sections. A first pre-filtration section contains microbial or particulate grade pre-filter material 54^{IV} such as non-woven polypropylene, glass fiber or activated carbon to capture and retain any organic matter and organic chemical contaminants in the water being purified. A second section is a reverse osmosis filter 58^{IV} that will capture and retain any remaining nuclear, biological and chemical contaminants TICs and TIMs. Common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors. Alternatively, reverse osmosis assembly 44 or reverse osmosis assembly 44′ may be used in place of reverse osmosis filter assembly 44^{IV} in this embodiment of water purification apparatus 10^{IV}.

To operate water purification apparatus 10^{IV}, unpurified water is collected into the contaminated water bag, first bag chamber 12^{IV}. In this initial step, any manually-operated valves (other than pressure relief, or vent and vent valve assemblies) are placed in the closed position. Threaded plug 24^{IV} is unscrewed from first bag chamber inlet 14^{IV} to permit unpurified water to be poured into the inlet, which may have a diameter of approximately one inch. It should be understood that the diameter of the inlet can be set to any dimension and remain within the scope of the disclosure. Once first bag chamber 12^{IV} has been filled, threaded plug 24^{IV} is secured back into first bag chamber inlet 14^{IV}. A threaded plug is used to ensure the bag remains closed when pressurized. Other mechanical interference engagement features, e.g., bayonet-style connections, may be used to secure plug 24^{IV} in first bag chamber inlet 14^{IV}. All three bag chambers, 12^{IV}a. 12^{IV}b and 12^{IV}c are constructed to have high burst pressure tolerances and be compatible with potable water quality as disclosed in more detail below. A pressure relief valve 20^{IV} may be secured to tri-chamber bag 12^{IV} and in fluid communication with the first bag chamber 12^{IV}a. Pressure relief valve 20^{IV} is set to ensure the burst pressure limit of first bag 12^{IV} is not exceeded. It further may be used to vent or purge air or other gases from first bag chamber 12^{IV} when filling the bag with unfiltered fluids.

With first bag chamber 12^{IV} filled with raw and/or contaminated water and first bag chamber inlet 14^{IV} closed via inlet plug 24^{IV}, a pressurized-gas-receiving port in the form of a soda-siphon-type cartridge/spigot (not shown) is inserted into soda siphon-type inlet valve port 22^{IV} manually or via a soda-siphon cartridge gun. Both the cartridge and cartridge gun are made from lightweight materials for portability purposes. The soda-siphon style cartridge also may be torqued into the soda-siphon-type inlet valve via mating threading on the cartridge and the inlet valve. Before activating the soda-siphon cartridge, the various manually-operated valves between the bags are opened to ensure fluid communication from the three bag chambers and reverse osmosis filter assembly 44^{IV}. With the valves in the open position, (and the second bag chamber check valve(s) and sip tube check valve in their closed positions), the soda-siphon cartridge is activated to infuse a high-pressure gas into the first bag chamber. The gas pressurizes the unpurified water to a pressure in excess of 60 psi to urge and facilitate the flow of unpurified water through reverse osmosis filter assembly 44^{IV} (or 44 or 44′).

Water passing through reverse osmosis filter assembly 44^{IV} will now be in a purified state before entering third bag chamber 12^{IV}c as a filtered permeate. The retentate generated by the filtration process will enter second bag chamber 12^{IV}b. Depending upon the volume of retentate that enters the second bag chamber, the retentate will flow into first bag chamber 12^{IV}a via one or more cross-chamber valve(s) 15^{IV}. To encourage preferential flow through the reverse osmosis membrane, the reverse osmosis retentate port quick disconnect 53^{IV} has a constricted internal diameter that creates back pressure. An optional water level sensor (not shown) may be secured within third bag chamber 12^{IV}c to alert the user when the chamber is full. The gas used to force the water through reverse osmosis filter 44^{IV} will not escape first bag chamber 12^{IV} and pass through the filter as the pressure of the gas is set to be below the bubble point of the reverse osmosis filter. When the purification process is complete, the pressure in the apparatus can be released via manual operation of pressure relief valve 20^{IV}.

To access the purified water for drinking, the user simply inserts either third bag chamber outlet port 36^{IV} or flexible sip tube 40^{IV} into their mouth and applies suction to either the port or tube to overcome the check valves to allow purified water to flow out of third bag chamber 12^{IV}c and into the user's mouth. Additionally, the purified water can be transferred to another container for storage and future use for drinking and cooking. Once emptied, water purification apparatus 10^{IV} can be folded for storage and future use. Any gas canister used to pressurize the system can simply be removed from the assembly and discarded.

Reverse osmosis filter assembly 44^{IV} can be used multiple times before replacement is necessary. When the filter has reached its usable limit, the filter can simply be swapped out with a new filter via the quick connects.

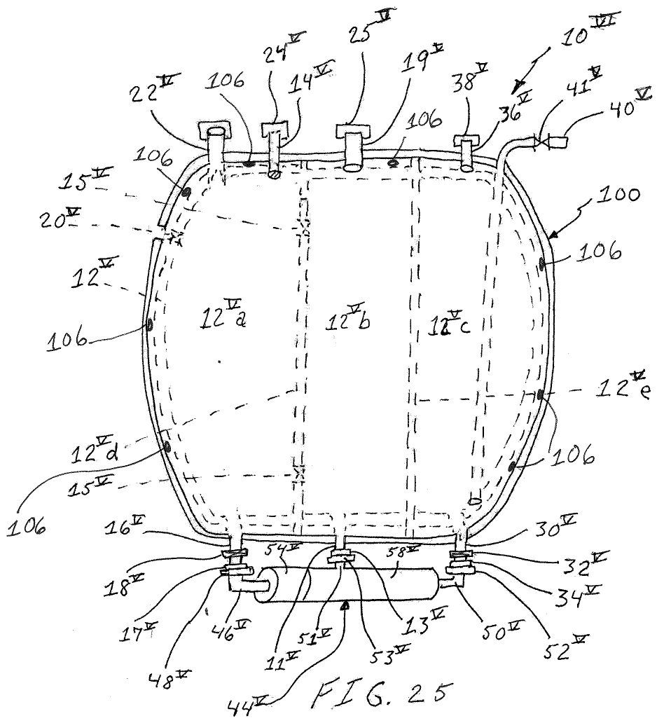

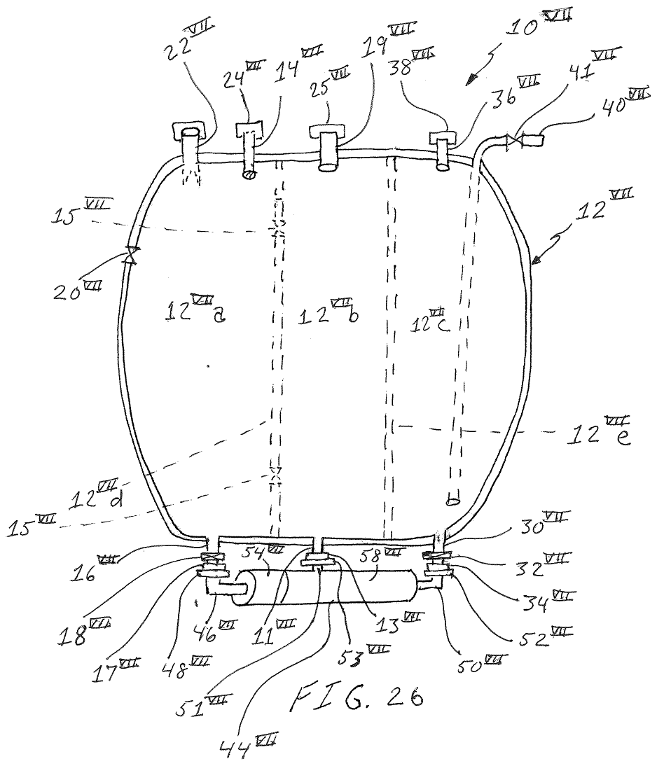

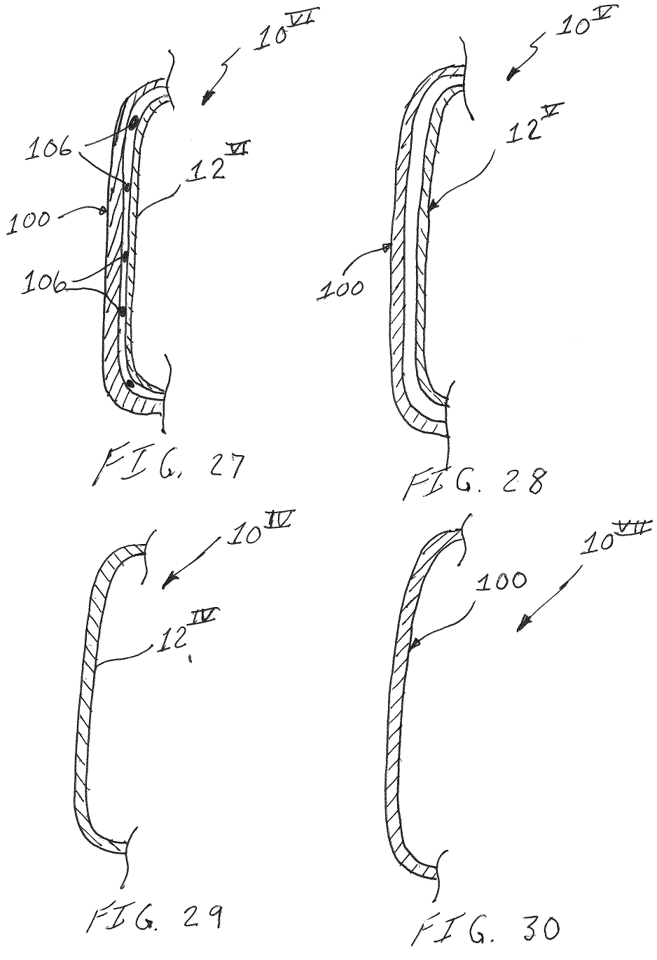

Referring now to FIGS. 24 and 27, a water purification apparatus, designated generally as 10^{V}, includes a hard-shell casing, designated generally as 100, and a replaceable tri-chamber bag or tri-chamber bladder 12^{V} (shown in phantom) secured in hard-shell casing 100. Tri-chamber bag 12^{V} may be releasably secured in hard-shell casing 100 via clips, Velcro strips or other releasable attachment means. Tri-chamber bag 12^{V} having a first bag chamber 12^{V}a designated as a contaminated water chamber defined by the outer wall of tri-chamber bag 12^{V} and a first chamber partition wall 12^{V}d. A second bag chamber 12^{V}b is designated as a retentate chamber defined by the outer wall of tri-chamber bag 12^{V}, first chamber partition wall 12^{V}d and a second chamber partition wall 12^{V}. A third bag chamber 12^{V}c is designated as a purified water chamber defined by the outer wall of tri-chamber bag 12^{V} and second chamber partition wall 12^{V}e.

Tri-chamber bag 12^{V} is essentially a flexible, pliable and/or stretchable bag that can expand with the introduction of liquids and/or gases into a volumetrically modifiable bag. First bag chamber 12^{V}a has a raw water inlet port 14^{V} extending from a top or upstream end of tri-chamber bag 12^{V} with optional internal or external threading to receive a first bag inlet plug or cap 24^{V} with optional external or internal threading dimensioned and spaced to match the dimensions and spacing of the first bag inlet internal or external threading. In an alternate embodiment, inlet plug 24^{V} may be a tapered elastomeric plug that secures into raw water inlet port 14^{V} via a friction fit or a plug with bayonet-style engagement features. Raw water inlet port 14^{V} is in fluid communication with first bag chamber 12^{V}a and may be used to collect water. A first chamber inlet port screen 14^{V}a may be secured to a bottom end of raw water inlet port 14^{V} to filter out particulate matter if the port is used to collect water. The port's distal end may be enlarged to improve water capture. It should be understood that for orientation purposes, the top end of tri-chamber bag 12^{V} is determined by the location of raw water inlet port 14^{V}.

First bag chamber 12^{V}a further includes a first bag chamber outlet port 16^{V} that extends from a bottom end of tri-chamber bag 12^{V}. A first bag chamber outlet valve 18^{V} secured to a distal end of first bag chamber outlet port 16^{V} provides a means to open and close the outlet. A distal end of first bag chamber outlet port 16^{V} may be formed as, or have secured thereto, a first bag chamber outlet port quick disconnect 17^{V} may be either a male or female end of a quick disconnect for attachment to a hose or tube with the corresponding female or male quick disconnect secured to an inlet port of a reverse osmosis assembly disclosed in detail hereinbelow. It should be understood that outlet valve 18^{V} and first bag chamber outlet port quick disconnect 17^{V} can be a combination component. First bag chamber outlet port 16^{V} is in fluid communication with first bag chamber 12^{V}a. First bag chamber outlet valve 18^{V} is closed initially when filling first bag chamber 12^{V}a with unfiltered raw water or other liquid. If a combination quick disconnect and shut-off valve is used, connection of the male and female components of the quick disconnect will open the shut-off valve. Conversely, disconnection of the quick disconnect components will close the shut-off valve to ensure liquids in first bag chamber 12^{V}a will be retained in the chamber.

Tri-chamber bag 12^{V} further includes a pressurized-gas-receiving port in the form of a soda-siphon-type inlet and valve assembly port 22^{V} secured to a top end of tri-chamber bag 12^{V}. Soda-siphon-type inlet and valve assembly port 22^{V} is essentially a check valve that permits the attachment of a soda-siphon-type cartridge/spigot to introduce pressurized gas into the apparatus as disclosed in more detail herein. It should be understood that the location of soda-siphon-type inlet and valve assembly port 22^{V} is not limited to the top end of tri-chamber bag 12^{V} but may be positioned on any end or outer surface of tri-chamber bag 12^{V}. Soda-siphon-type inlet valve port 22^{V} is in fluid communication with first bag chamber 12^{V}a. It should further be understood that other connection means, e.g., threaded ports and/or threaded ports with Schrader valves, i.e., a Schrader valve port, can be substituted for, or provided in addition to, the siphon-type inlet valve port to accommodate other pressurized gas sources such as tire inflation cannisters with flexible tubes having Schrader valve engagement features or hand-held cannisters with threaded connection means.

Second bag chamber 12^{V}b has a series of ports, each of which is assigned a specific function. A second bag chamber inlet port 11^{V} is positioned at a bottom end of second bag chamber 12^{V}b, which represents the upstream end of the second bag chamber when a filtration function is performed. Second bag chamber inlet port 11^{V} is in fluid communication with second bag chamber 12^{V}b and provides an inlet for retentate produced by a reverse osmosis filter as described in more detail herein. A distal end of second bag chamber inlet port 11^{V} is formed with, or has attached thereto, a second bag chamber quick disconnect and shut-off valve 13^{V}. It should be understood that the quick disconnect and valve can be two separate devices. If separate, a separate shut-off valve has to be operated manually. As is well known in the art, there is a female component and a male component to a quick disconnect. Either component can be secured to second bag chamber inlet port 11^{V} with the corresponding component connected to a retentate port of a reverse osmosis filter as disclosed in more detail herein. By design, by connecting the two components of the quick disconnect causes the shut-off valve to open. By disconnecting the two components, the shut-off valve will close and prevent any leakage of liquids or gases out of second bag chamber 12^{V}b.

At least one cross-chamber valve 15^{V} is formed in first chamber partition wall 12^{V}d and provides a travel path for retentate to flow back into first bag chamber 12^{V}a for further filtration. By design, cross-chamber valve 15^{V} is a one-way valve, such as a check valve, to permit liquids within second bag chamber 12^{V}b to only flow into first bag chamber 12^{V}a. A pressure gradient formed between second bag chamber 12^{V}b and first bag chamber 12^{V}a, with the higher pressure in the second bag chamber, will open cross-chamber valve 15^{V}. By using a one-way valve, any pressurization of first bag chamber 12^{V}a during a filtration event will not allow raw water to flow into second bag chamber 12^{V}b and only flow out of first bag chamber outlet port 16^{V}. It should be understood that more than one cross-chamber valve 15^{V} may be positioned at various locations along chamber partition wall 12^{V}d to increase the volume flow between the two chambers.

Second bag chamber 12^{V}b further includes a second bag chamber outlet port 19^{V} positioned at a top end of tri-chamber bag 12^{V}. Second bag chamber outlet port 19^{V} is in fluid communication with second bag chamber 12^{V}b and provides a means to drain any retentate remaining in the second bag chamber after a filtration event. This can be done also to lighten the load being carried by the user if retention of the retentate for future filtration is not necessary. For example, if raw water is readily available along an excursion, a user can discard or discharge the retentate.

Second bag chamber outlet port 19^{V} can have optional internal or external threading to receive a second bag chamber inlet plug or cap 25^{V} with optional external or internal threading dimensioned and spaced to match the dimensions and spacing of the second bag chamber outlet port internal or external threading. In an alternate embodiment, second bag chamber inlet plug 25^{V} may be a tapered elastomeric plug that secures into second bag chamber outlet port 19^{V} via a friction fit or a plug with bayonet-style engagement features.

Third bag chamber 12^{V}c includes several ports. A third chamber bag inlet port 30^{V} extending from a bottom end of tri-chamber bag 12^{V} with a third bag chamber inlet shut-off valve 32^{V} and a third bag chamber inlet male or female quick disconnect 34^{V} formed on, or attached thereto. Third bag chamber inlet 30^{V} is in fluid communication with the third bag chamber 12^{V}c. As with other inlet valves disclosed herein, a combination quick disconnect and shut-off valve can be used in place of separate quick disconnect and shut-off valve devices. If separate devices are used, each has to be operated separately. If the combination is used, disengagement or engagement of the quick-disconnect will close or open the shut-off valve, respectively.

Third bag chamber 12^{V}c further includes a third bag chamber outlet port 36^{V} that extends from a top end of third bag chamber 12^{V}c is in fluid communication with the third bag chamber. Third bag chamber outlet port 36^{V} may have internal or external threading to receive a third bag chamber outlet port cap 38^{V} having external or internal threading corresponding to the threading of the outlet port. Third bag chamber outlet port 36^{V} provides a means to extract filtered, potable water from the third bag chamber as either a drinking port or as an attachment point for other secondary water extraction delivery or storage devices. Third bag chamber outlet port 36^{V} is closed initially when filling first bag chamber 12^{V}a with unfiltered water or other liquid. A gas vent and valve assembly (not shown) may be secured to third bag chamber 12^{V} to permit the purging of air or other gases and/or liquids when third bag chamber 12^{V} is receiving filtered liquid from a reverse osmosis filter as described in more detail hereinbelow.

Also extending from a top end of tri-chamber bag 12^{V} is an optional flexible sip tube 40^{V}. A sip tube valve 41^{V} in the form of a check valve permits one-way transfer of purified water out of third bag chamber 12^{V}c via sip tube 40^{V}. When suction pressure is not applied to a proximal end, sip tube valve 41^{V} prevents water within the third bag chamber from leaking out. A distal end of sip tube 40^{V} can extend within third bag chamber 12^{V}c proximal to a bottom of the chamber to enable most of the purified water to be sucked out of the bag via sip tube 40^{V}. Alternatively, the outlet port for drinking water may be at the base of bag 12^{IV}c with an external flexible sip hose not shown in the drawing.

Secured to the three ports extending from the bottom end of tri-chamber bag 12^{V} is a reverse osmosis filter assembly, designated generally as 44^{V}. Reverse osmosis filter assembly 44^{V} can be permanently affixed to the ports or secured thereto with the quick connect assemblies secured to the ports as disclosed hereinabove. In one embodiment, reverse osmosis filter assembly 44^{V} has a reverse osmosis inlet port 46^{V} with a first filter quick disconnect 48^{V} that is either the male or female quick disconnect end that corresponds to the female or male first bag chamber outlet port quick disconnect 17^{V}. Connection of the corresponding quick disconnect ends connects first bag outlet port 16^{IV} to reverse osmosis inlet port 46^{V} to render first bag chamber 12^{V}a to be in fluid communication with the internal chambers of reverse osmosis filter assembly 44^{V}.

Reverse osmosis filter assembly 44^{V} further has a reverse osmosis outlet port 50^{V} with a second filter quick disconnect 52^{V}. Second filter quick disconnect 52^{V} can be either a male or a female quick disconnect connector end to correspond to the male or female version of third bag chamber quick disconnect 34^{V}. With the corresponding quick disconnect ends connected, reverse osmosis outlet 50^{V} and third bag chamber inlet port 30^{V} will be in fluid communication with each other as well as with third bag chamber 12^{V}c and the internal area of reverse osmosis assembly 44^{V}. In one embodiment, all stages of filtration are contained in a single filter cartridge/assembly equipped with a quick disconnect male inlet and a quick disconnect female outlet with a corresponding female quick disconnect first bag chamber outlet and a male quick disconnect third bag chamber inlet. The male/female orientations of the reverse osmosis filter assembly inlet and outlet prevent the cartridge from being assembled in the incorrect direction of water flow.

Reverse osmosis filter assembly 44^{V} has a third reverse osmosis retentate port 51^{V} that extends from a side wall of the filter assembly at a point between the two ends of the filter assembly. Third reverse osmosis retentate port 51^{V} provides an exit point for retentate captured by a reverse osmosis filter secured in reverse osmosis filter assembly 44^{V}. A third reverse osmosis retentate port quick disconnect 53^{V} is secured to an end of third reverse osmosis retentate port 51^{V} and may be either a male or a female quick disconnect connector end to correspond to the male or female version of second bag chamber quick disconnect and shut-off valve 13^{V}. Connection of the corresponding quick disconnect components will render second bag chamber 12^{V}b to be in fluid communication with the internal area of reverse osmosis filter assembly 44^{V}. It should be understood with water purification apparatus 10^{V} that all the tri-chamber ports, other than the ports connected to reverse osmosis filter assembly 44^{V}, will have a dedicated port outlet formed in hard-shell case 100.

Reverse osmosis filter assembly 44^{V} is in a capsule or in a cartridge form with two distinct sections. A first pre-filtration section contains microbial or particulate grade pre-filter material 54^{V} such as non-woven polypropylene, glass fiber or activated carbon to capture and retain any organic matter and organic chemical contaminants in the water being purified. A second section is a reverse osmosis filter 58^{V} that will capture and retain any remaining nuclear, biological and chemical contaminants. Common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors. Alternatively, reverse osmosis assembly 44 or reverse osmosis assembly 44′ may be used in place of reverse osmosis filter assembly 44^{V} in this embodiment of water purification apparatus 10^{V}.

To operate water purification apparatus 10^{V}, unpurified water is collected into the contaminated water bag, first bag chamber 12^{V}. In this initial step, any manually-operated valves (other than pressure relief, or vent and vent valve assemblies) are placed in the closed position. Threaded plug 24^{V} is unscrewed from first bag chamber inlet 14^{V} to permit unpurified water to be poured into the inlet, which may have a diameter of approximately one inch. It should be understood that the diameter of the inlet can be set to any dimension and remain within the scope of the disclosure. Once first bag chamber 12^{V} has been filled, threaded plug 24^{V} is secured back into first bag chamber inlet 14^{V}. A threaded plug is used to ensure the bag remains closed when pressurized. Other mechanical interference engagement features, e.g., bayonet-style connections, may be used to secure plug 24^{V} in first bag chamber inlet 14^{V}. All three bag chambers, 12^{V}a. 12^{V}b and 12^{V}c are constructed to have high burst pressure tolerances and be compatible with potable water quality as disclosed in more detail below. A pressure relief valve 20^{V} may be secured to tri-chamber bag 12^{V} and in fluid communication with the first bag chamber 12^{V}a. Pressure relief valve 20^{V} is set to ensure the burst pressure limit of first bag 12^{V} is not exceeded. It further may be used to vent or purge air or other gases from first bag chamber 12^{V} when filling the bag with unfiltered fluids.

With first bag chamber 12^{V} filled with raw and/or contaminated water and first bag chamber inlet 14^{V} closed via inlet plug 24^{V}, a soda-siphon-type cartridge/spigot (not shown) is inserted into soda siphon-type inlet valve port 22^{V} manually or via a soda-siphon cartridge gun. Both the cartridge and cartridge gun are made from lightweight materials for portability purposes. The soda-siphon style cartridge also may be torqued into the soda-siphon-type inlet valve via mating threading on the cartridge and the inlet valve. Before activating the soda-siphon cartridge, the various manually-operated valves between the bags are opened to ensure fluid communication from the three bag chambers and reverse osmosis filter assembly 44^{V}. With the valves in the open position, (and the second bag chamber check valve(s) and sip tube check valve in their closed positions), the soda-siphon cartridge is activated to infuse a high-pressure gas into the first bag chamber. The gas pressurizes the unpurified water to a pressure in excess of 60 psi to urge and facilitate the flow of unpurified water through reverse osmosis filter assembly 44^{V} (or 44 or 44′).

Water passing through reverse osmosis filter assembly 44^{V} will now be in a purified state before entering third bag chamber 12^{V}c as a filtered permeate. The retentate generated by the filtration process will enter second bag chamber 12^{V}b. Depending upon the volume of retentate that enters the second bag chamber, the retentate will flow into first bag chamber 12^{V}a via one or more cross-chamber valve(s) 15^{V}. An optional water level sensor (not shown) may be secured within third bag chamber 12^{V}c to alert the user when the chamber is full. The gas used to force the water through reverse osmosis filter 44^{V} will not escape first bag chamber 12^{V} and pass through the filter as the pressure of the gas is set to be below the bubble point of the reverse osmosis filter. When the purification process is complete, the pressure in the apparatus can be released via manual operation of pressure relief valve 20^{V}.

To access the purified water for drinking, the user simply inserts either third bag chamber outlet port 36^{V} or a proximal end of flexible sip tube 40^{V} into their mouth and applies suction to either the port or tube to overcome the check valves to allow purified water to flow out of third bag chamber 12^{V}c and into the user's mouth. Additionally, the purified water can be transferred to another container for storage and future use for drinking and cooking. Once emptied, water purification apparatus 10^{V} can be folded for storage and future use. Any gas canister used to pressurize the system can simply be removed from the assembly and discarded.

Reverse osmosis filter assembly 44^{V} can be used multiple times before replacement is necessary. When the filter has reached its usable limit, the filter can simply be swapped out with a new filter via the quick connects. To that end, referring now to FIGS. 28 and 29, a filter access door 102 having at least one hinge and at least one latch is positioned on a back wall of hard-shell casing 100 over the location of reverse osmosis filter assembly 44^{V}. A bladder access door 104 with at least one hinge and at least one latch is provided on a back wall of hard-shell casing 100 to enable access to tri-chamber bladder 12^{V} for repair and/or replacement. The port orifices formed in hard-shell casing 100 to accommodate the various bladder ports as disclosed herein are dimensioned to permit tri-chamber bladder 12^{V} to be removed or inserted into the casing.

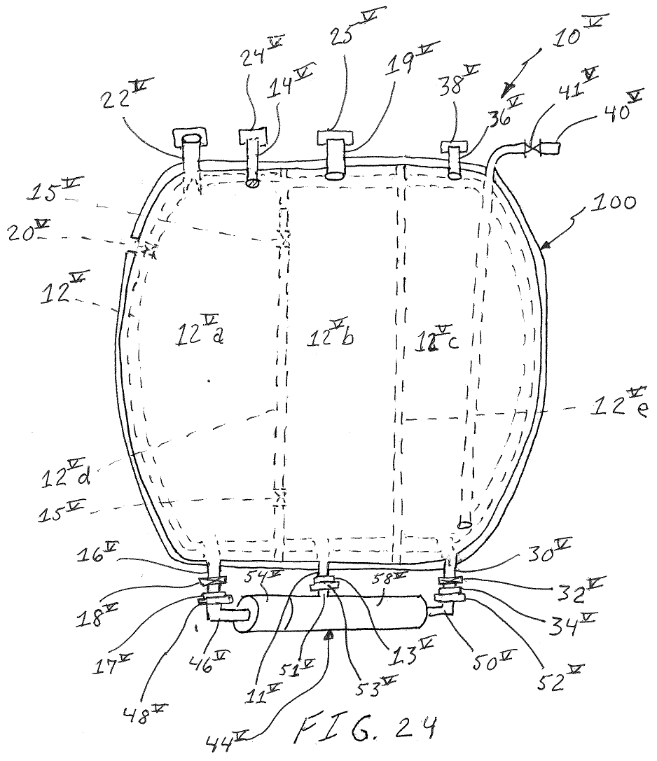

Referring now to FIGS. 25 and 27, a water purification apparatus, designated generally as 10^{VI}, includes all the features of water purification apparatus 10^{V} including a hard-shell casing and a tri-chamber bladder positioned within the hard-shell casing. To that extent, the water purification apparatus 10^{VI}, shown in FIGS. 22 and 24, is identical to the water purification apparatus 10^{V}, shown in FIGS. 21 and 25 and has identical features and identical reference characters with one exception. In this embodiment, the tri-chamber bladder is fixed to the interior wall of the hard-shell casing with adhesive 106 or other fixation means such as mechanical fasteners and attachment tabs formed on the tri-chamber bladder and the hard-shell casing inner wall with bore holes formed in the tabs to receive the mechanical fasteners. Hot melt glue is another fixation option. It should be understood that any fixation means is within the scope of the disclosure. This embodiment is intended for disposal after the reverse osmosis filtration cartridge is exhausted.

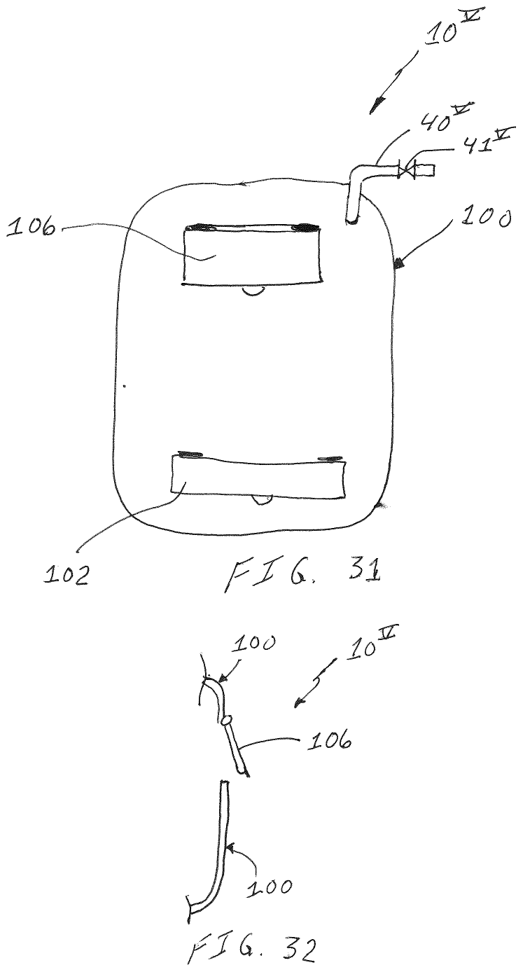

Referring now to FIGS. 26 and 30, a water purification apparatus designated generally as 10^{VII} includes a tri-chamber hard-shell casing 12^{VII} having a first casing chamber 12^{VII}a designated as a contaminated water chamber defined by the outer wall of tri-chamber casing 12^{VII} and a first chamber partition wall 12^{VII}d. A second casing chamber 12^{VII}b is designated as a retentate chamber defined by the outer wall of tri-chamber casing 12^{VII}, first chamber partition wall 12^{VII}d and a second chamber partition wall 12^{VII}e. A third casing chamber 12^{VII}c is designated as a purified water chamber defined by the outer wall of tri-chamber casing 12^{VII} and second chamber partition wall 12^{VII}e. Tri-chamber casing 12^{VII} is essentially a flexible, pliable and/or stretchable bag that can expand with the introduction of liquids and/or gases into a volumetrically modifiable bag.

First casing chamber 12^{VII}a has a raw water inlet port 14^{VII} extending from a top or upstream end of tri-chamber casing 12^{VII} with optional internal or external threading to receive a first casing inlet plug or cap 24^{VII} with optional external or internal threading dimensioned and spaced to match the dimensions and spacing of the first casing inlet internal or external threading. In an alternate embodiment, inlet plug or cap 24^{VII} may be a tapered elastomeric plug that secures into raw water inlet port 14^{VII} via a friction fit or a plug with bayonet-style engagement features. Raw water inlet port 14^{VII} is in fluid communication with first casing chamber 12^{VII}a and may be used to collect water. A first chamber inlet port screen 14^{VII}a may be secured to a bottom end of raw water inlet port 14^{VII} to filter out particulate matter if the port is used to collect water. The port's distal end may be enlarged to improve water capture. It should be understood that for orientation purposes, the top end of tri-chamber casing 12^{VII} is determined by the location of raw water inlet port 14^{VII}.

First casing chamber 12^{VII}a further includes a first casing chamber outlet port 16^{VII} that extends from a bottom end of tri-chamber casing 12^{VII}. A first casing chamber outlet valve 18^{VII} secured to a distal end of first casing chamber outlet port 16^{VII} provides a means to open and close the outlet. A distal end of first casing chamber outlet port 16^{VII} may be formed as, or have secured thereto, a first casing chamber outlet port quick disconnect 17^{VII} may be either a male or female end of a quick disconnect for attachment to a hose or tube with the corresponding female or male quick disconnect secured to an inlet port of a reverse osmosis assembly disclosed in detail hereinbelow. It should be understood that outlet valve 18^{VII} and first casing chamber outlet port quick disconnect 17^{VII} can be a combination component. First casing chamber outlet port 16^{VII} is in fluid communication with first casing chamber 12^{VII}a. First casing chamber outlet valve 18^{VII} is closed initially when filling first casing chamber 12^{VII}a with unfiltered raw water or other liquid. If a combination quick disconnect and shut-off valve is used, connection of the male and female components of the quick disconnect will open the shut-off valve. Conversely, disconnection of the quick disconnect components will close the shut-off valve to ensure liquids in first casing chamber 12^{VII}a will be retained in the chamber.

Tri-chamber casing 12^{VII} further includes a pressurized-gas-receiving port in the form of a soda-siphon-type inlet and valve assembly port 22^{VII} secured to a top end of tri-chamber casing 12^{VII}. Soda-siphon-type inlet and valve assembly port 22^{VII} is essentially a check valve that permits the attachment of a soda-siphon-type cartridge/spigot to introduce pressurized gas into the apparatus as disclosed in more detail herein. It should be understood that the location of soda-siphon-type inlet and valve assembly port 22^{VII} is not limited to the top end of tri-chamber casing 12^{VII} but may be positioned on any end or outer surface of tri-chamber casing 12^{VII}. Soda-siphon-type inlet valve port 22^{VII} is in fluid communication with first casing chamber 12^{VII}a.

Second casing chamber 12^{VII}b has a series of ports, each of which is assigned a specific function. A second casing chamber inlet port 11^{VII} is positioned at a bottom end of second casing chamber 12^{VII}b, which represents the upstream end of the second casing chamber when a filtration function is performed. Second casing chamber inlet port 11^{VII} is in fluid communication with second casing chamber 12^{VII}b and provides an inlet for retentate produced by a reverse osmosis filter as described in more detail herein. A distal end of second casing chamber inlet port 11^{VII} is formed with, or has attached thereto, a second casing chamber quick disconnect and shut-off valve 13^{VII}. It should be understood that the quick disconnect and valve can be two separate devices. If separate, a separate shut-off valve has to be operated manually. As is well known in the art, there is a female component and a male component to a quick disconnect. Either component can be secured to second casing chamber inlet port 11^{VII} with the corresponding component connected to a retentate port of a reverse osmosis filter as disclosed in more detail herein. By design, by connecting the two components of the quick disconnect causes the shut-off valve to open. By disconnecting the two components, the shut-off valve will close and prevent any leakage of liquids or gases out of second casing chamber 12^{VII}b.

At least one cross-chamber valve 15^{VII} is formed in first chamber partition wall 12^{VII}d and provides a travel path for retentate to flow back into first casing chamber 12^{VII}a for further filtration. By design, cross-chamber valve 15^{VII} is a one-way valve, such as a check valve, to permit liquids within second casing chamber 12^{VII}b to only flow into first casing chamber 12^{VII}a. A pressure gradient formed between second casing chamber 12^{VII}b and first casing chamber 12^{VII}a, with the higher pressure in the second casing chamber, will open cross-chamber valve 15^{VII}. By using a one-way valve, any pressurization of first casing chamber 12^{VII}a during a filtration event will not allow raw water to flow into second casing chamber 12^{VII}b and only flow out of first casing chamber outlet port 16^{VII}. It should be understood that more than one cross-chamber valve 15^{VII} may be positioned at various locations along chamber partition wall 12^{VII}d to increase the volume flow between the two chambers.

Second casing chamber 12^{VII}b further includes a second casing chamber outlet port 19^{VII} positioned at a top end of tri-chamber casing 12^{VII}. Second casing chamber outlet port 19^{VII} is in fluid communication with second casing chamber 12^{VII}b and provides a means to drain any retentate remaining in the second casing chamber after a filtration event. This can be done also to lighten the load being carried by the user if retention of the retentate for future filtration is not necessary. For example, if raw water is readily available along an excursion, a user can discard or discharge the retentate.

Second casing chamber outlet port 19^{VII} can have optional internal or external threading to receive a second casing chamber inlet plug or cap 24^{VII} with optional external or internal threading dimensioned and spaced to match the dimensions and spacing of the second casing chamber outlet port internal or external threading. In an alternate embodiment, second casing chamber inlet plug 25^{VII} may be a tapered elastomeric plug that secures into second casing chamber outlet port 19^{VII} via a friction fit or a plug with bayonet-style engagement features.

Third casing chamber 12^{VII}c includes several ports. A third chamber casing inlet port 30^{VII} extending from a bottom end of tri-chamber casing 12^{VII} with a third casing chamber inlet shut-off valve 32^{VII} and a third casing chamber inlet male or female quick disconnect 34^{VII} formed on, or attached thereto. Third casing chamber inlet 30^{VII} is in fluid communication with the third casing chamber 12^{VII}c. As with other inlet valves disclosed herein, a combination quick disconnect and shut-off valve can be used in place of separate quick disconnect and shut-off valve devices. If separate devices are used, each has to be operated separately. If the combination is used, disengagement or engagement of the quick-disconnect will close or open the shut-off valve, respectively.

Third casing chamber 12^{VII}c further includes a third casing chamber outlet port 36^{VII} that extends from a top end of third casing chamber 12^{VII}c is in fluid communication with the third casing chamber. Third casing chamber outlet port 36^{VII} may have internal or external threading to receive a third casing chamber outlet port cap 38^{VII} having external or internal threading corresponding to the threading of the outlet port. Third casing chamber outlet port 36^{VII} provides a means to extract filtered, potable water from the third casing chamber as either a drinking port or as an attachment point for other secondary water extraction delivery or storage devices. Third casing chamber outlet port 36^{IV} is closed initially when filling first casing chamber 12^{VII} with unfiltered water or other liquid. A gas vent and valve assembly (not shown) may be secured to third casing chamber 12^{VII} to permit the purging of air or other gases and/or liquids when third casing chamber 12^{VII} is receiving filtered liquid from a reverse osmosis filter as described in more detail hereinbelow.

Also extending from a top end of tri-chamber casing 12^{VII} is an optional flexible sip tube 40^{VII}. A sip tube valve 41^{VII} in the form of a check valve permits one-way transfer of purified water out of third casing chamber 12^{VII}c via sip tube 40^{VII}. When suction pressure is not applied to a proximal end, sip tube valve 41^{VII} prevents water within the third casing chamber from leaking out. A distal end of sip tube 40^{VII} can extend within third casing chamber 12^{VII}c proximal to a bottom of the chamber to enable most of the purified water to be sucked out of the casing via sip tube 40^{VII}.

Secured to the three ports extending from the bottom end of tri-chamber casing 12^{VII} is a reverse osmosis filter assembly, designated generally as 44^{VII}. Reverse osmosis filter assembly 44^{VII} can be permanently affixed to the ports or secured thereto with the quick connect assemblies secured to the ports as disclosed hereinabove. In one embodiment, reverse osmosis filter assembly 44^{VII} has a reverse osmosis inlet port 46^{VII} with a first filter quick disconnect 48^{VII} that is either the male or female quick disconnect end that corresponds to the female or male first casing chamber outlet port quick disconnect 17^{VII}. Connection of the corresponding quick disconnect ends connects first casing outlet port 16^{VII} to reverse osmosis inlet port 46^{VII} to render first casing chamber 12^{VII}a to be in fluid communication with the internal chambers of reverse osmosis filter assembly 44^{VII}.

Reverse osmosis filter assembly 44^{VII} further has a reverse osmosis outlet port 50^{VII} with a second filter quick disconnect 52^{VII}. Second filter quick disconnect 52^{VII} can be either a male or a female quick disconnect connector end to correspond to the male or female version of third casing chamber quick disconnect 34^{VII}. With the corresponding quick disconnect ends connected, reverse osmosis outlet 50^{VII} and third casing chamber inlet port 30^{VII} will be in fluid communication with each other as well as with third casing chamber 12^{VII}c and the internal area of reverse osmosis assembly 44^{VII}. In one embodiment, all stages of filtration are contained in a single filter cartridge/assembly equipped with a quick disconnect male inlet and a quick disconnect female outlet with a corresponding female quick disconnect first casing chamber outlet and a male quick disconnect third casing chamber inlet. The male/female orientations of the reverse osmosis filter assembly inlet and outlet prevent the cartridge from being assembled in the incorrect direction of water flow.

Reverse osmosis filter assembly 44^{VII} has a third reverse osmosis retentate port 51^{VII} that extends from a side wall of the filter assembly at a point between the two ends of the filter assembly. Third reverse osmosis retentate port 51^{VII} provides an exit point for retentate captured by a reverse osmosis filter secured in reverse osmosis filter assembly 44^{VII}. A third reverse osmosis retentate port quick disconnect 53^{VII} is secured to an end of third reverse osmosis retentate port 51^{VII} and may be either a male or a female quick disconnect connector end to correspond to the male or female version of second casing chamber quick disconnect and shut-off valve 13^{VII}. Connection of the corresponding quick disconnect components will render second casing chamber 12^{VII}b to be in fluid communication with the internal area of reverse osmosis filter assembly 44^{VII}.

Reverse osmosis filter assembly 44^{VII} is in a capsule or in a cartridge form with two distinct sections. A first pre-filtration section contains microbial or particulate grade pre-filter material 54^{VII} such as activated carbon to capture and retain any organic matter and organic chemical contaminants in the water being purified. A second section is a reverse osmosis filter 58^{VII} that will capture and retain any remaining nuclear, biological and chemical contaminants. Common contaminants removed by reverse osmosis filters include illustratively, Arsenic, Cyanide, Mercury, Chloroform, Benzene, Toluene, Trimethylbenzene, Naphthalene, Aldicarb, Methamidophos, Paraquat Dichloride, Uranium, dissolved solids, bacteria, protozoa, viruses, fungi and other viral-based vectors. Alternatively, reverse osmosis assembly 44 or reverse osmosis assembly 44′ may be used in place of reverse osmosis filter assembly 44^{VII} in this embodiment of water purification apparatus 10^{VII}.

To operate water purification apparatus 10^{VII}, unpurified water is collected into the contaminated water casing, first casing chamber 12^{VII}. In this initial step, any manually-operated valves (other than pressure relief, or vent and vent valve assemblies) are placed in the closed position. Threaded plug 24^{VII} is unscrewed from first casing chamber inlet 14^{VII} to permit unpurified water to be poured into the inlet, which may have a diameter of approximately one inch. It should be understood that the diameter of the inlet can be set to any dimension and remain within the scope of the disclosure. Once first casing chamber 12^{VII} has been filled, threaded plug 24^{VII} is secured back into first casing chamber inlet 14^{VII}. A threaded plug is used to ensure the casing remains closed when pressurized. Other mechanical interference engagement features, e.g., bayonet-style connections, may be used to secure plug 24^{IV} in first casing chamber inlet 14^{VII}. All three casing chambers, 12^{VII}a. 12^{VII}b and 12^{VII}c are constructed to have high burst pressure tolerances and be compatible with potable water quality as disclosed in more detail below. A pressure relief valve 20^{VII} may be secured to tri-chamber casing 12^{VII} and in fluid communication with the first casing chamber 12^{VII}a. Pressure relief valve 20^{VII} is set to ensure the burst pressure limit of first casing 12^{VII} is not exceeded. It further may be used to vent or purge air or other gases from first casing chamber 12^{VII} when filling the casing with unfiltered fluids.

With first casing chamber 12^{VII} filled with raw and/or contaminated water and first casing chamber inlet 14^{VII} closed via inlet plug 24^{VII}, a soda-siphon-type cartridge/spigot (not shown) is inserted into soda siphon-type inlet valve port 22^{VII} manually or via a soda-siphon cartridge gun. Both the cartridge and cartridge gun are made from lightweight materials for portability purposes. The soda-siphon style cartridge also may be torqued into the soda-siphon-type inlet valve via mating threading on the cartridge and the inlet valve. Before activating the soda-siphon cartridge, the various manually-operated valves between the casings are opened to ensure fluid communication from the three casing chambers and reverse osmosis filter assembly 44^{VII}. With the valves in the open position, (and the second casing chamber check valve(s) and sip tube check valve in their closed positions), the soda-siphon cartridge is activated to infuse a high-pressure gas into the first casing chamber. The gas pressurizes the unpurified water to a pressure in excess of 60 psi to urge and facilitate the flow of unpurified water through reverse osmosis filter assembly 44^{VII} (or 44 or 44′).

Water passing through reverse osmosis filter assembly 44^{VII} will now be in a purified state before entering third casing chamber 12^{VII}c as a filtered permeate. The retentate generated by the filtration process will enter second casing chamber 12^{VII}b. Depending upon the volume of retentate that enters the second casing chamber, the retentate will flow into first casing chamber 12^{VII}a via one or more cross-chamber valve(s) 15^{VII}. An optional water level sensor (not shown) may be secured within third casing chamber 12^{VII}c to alert the user when the chamber is full. The gas used to force the water through reverse osmosis filter 44^{VII} will not escape first casing chamber 12^{VII} and pass through the filter as the pressure of the gas is set to be below the bubble point of the reverse osmosis filter. When the purification process is complete, the pressure in the apparatus can be released via manual operation of pressure relief valve 20^{VII}.

To access the purified water for drinking, the user simply inserts either third casing chamber outlet port 36^{VII} or a proximal end of flexible sip tube 40^{VII} into their mouth and applies suction to either the port or tube to overcome the check valves to allow purified water to flow out of third casing chamber 12^{VII}c and into the user's mouth. Additionally, the purified water can be transferred to another container for storage and future use for drinking and cooking. Any gas canister used to pressurize the system can simply be removed from the assembly and discarded. Alternatively, the outlet port for drinking water may be at the base of bag 12^{IV}c with an external flexible sip hose not shown in the drawing.

Reverse osmosis filter assembly 44^{VII} can be used multiple times before replacement is necessary. When the filter has reached its usable limit, the filter can simply be swapped out with a new filter via the quick connects.

While the present disclosure has been described in connection with several embodiments thereof, it will be apparent to those skilled in the art that many changes and modifications may be made without departing from the true spirit and scope of the disclosure. Although both one-bag and two-bag apparatuses have been described herein as illustrative, non-limiting examples, it should be understood that multiple bags can be used depending upon the severity of the contamination including the addition of a second filter cartridge either before or after the filtration apparatus assembly and remain within the scope of the disclosure. Accordingly, it is intended by the appended claims to cover all such changes and modifications as come within the true spirit and scope of the disclosure.

What we claim as new and desire to secure by United States Letters Patent is:

1. A water purification apparatus comprising:
a first bag defining a first bag chamber for receiving raw water, wherein the first bag has a first bag inlet positioned at a top end of the first bag, a first bag outlet positioned at a bottom end of the first bag and a pressurized gas-receiving valve port positioned at a top end of the first bag, wherein the first bag chamber, first bag inlet, first bag outlet and pressurized-gas-receiving valve port are in fluid communication;
a second bag defining a second bag chamber for receiving purified water having a second bag inlet positioned at a top end of the second bag and a second bag outlet positioned at a bottom end of the second bag, wherein the second bag chamber, second bag inlet and second bag outlet are in fluid communication;
a hose with one end secured to the first bag outlet and a second end secured to the second bag inlet; and,
a reverse osmosis filter assembly having a reverse osmosis filter and secured in-line with the hose between the first bag and the second bag, wherein the reverse osmosis filter assembly is in fluid communication with the first bag chamber and the second bag chamber.

2. The water purification apparatus of claim 1 wherein the reverse osmosis filter assembly includes a first pre-filtration stage depth filter.

3. The water purification apparatus of claim 2 further comprising a second pre-filtration stage activated carbon filter.

4. The water purification apparatus of claim 1 wherein the pressurized-gas-receiving valve port is a soda siphon style valve port.

5. The water purification apparatus of claim 4 further comprising a soda siphon style valve cartridge, wherein the soda siphon style valve cartridge is secured to the soda siphon style valve port.

6. The water purification apparatus of claim 1 wherein the pressurized-gas-receiving valve port is a Schrader valve port.

7. The water purification apparatus of claim 6 further comprising a compressed air canister with a feed hose secured to the Schrader valve port.

8. The water purification apparatus of claim 1 further comprising a sip tube, wherein the sip tube has a distal end positioned within the second bag and a proximal end extending out of the second bag.

9. A single-bag water purification apparatus comprising:
a bag or bladder defining a bag chamber for receiving raw water, wherein the bag or bladder has an inlet positioned at a top end of the bag, an outlet positioned at a bottom end of the bag and a pressurized-gas-receiving valve port positioned at a top end of the bag, wherein the bag chamber, bag inlet, bag outlet and pressurized-gas-receiving valve port are in fluid communication; and,
a reverse osmosis filter assembly having a reverse osmosis filter secured in-line with the bag outlet.

10. The water purification apparatus of claim 9 wherein the reverse osmosis filter assembly includes a first pre-filtration stage depth filter.

11. The water purification apparatus of claim 10 further comprising a second pre-filtration stage activated carbon filter.

12. The water purification apparatus of claim 9 wherein the pressurized gas-receiving valve port is a soda siphon style valve port.

13. The water purification apparatus of claim 12 further comprising a soda siphon style valve cartridge, wherein the soda siphon style valve cartridge is secured to the soda siphon style valve port.

14. The water purification apparatus of claim 9 wherein the pressurized gas receiving valve port is a Schrader valve port.

15. The water purification apparatus of claim 14 further comprising a compressed air canister with a feed hose secured to the Schrader valve port.

16. The water purification apparatus of claim 9 further comprising a sip tube, wherein the sip tube has a distal end positioned within the second bag and a proximal end extending out of the second bag.

17. A water purification apparatus comprising:
a tri-chamber bag or bladder having a bag wall and a first partition wall defining a first bag chamber, a second partition wall, wherein the bag wall, the first partition wall and the second partition wall define a second bag chamber, wherein the bag wall and the second partition wall define a third bag chamber;
a first chamber bag inlet port connected to a top end of the bag wall, wherein the first chamber bag inlet port is in fluid communication with the first bag chamber;
a first chamber bag outlet port connected to a bottom end of the bag wall, wherein the first chamber bag outlet port is in fluid communication with the first bag chamber;
a second chamber bag inlet port connected to a top end of the bag wall, wherein the second chamber bag inlet port is in fluid communication with the second bag chamber;
a second chamber bag outlet port connected to a bottom end of the bag wall, wherein the second chamber bag outlet port is in fluid communication with the second bag chamber;
a third chamber bag inlet port connected to a top end of the bag wall, wherein the third chamber bag inlet port is in fluid communication with the third bag chamber;
a third chamber bag outlet port connected to a bottom end of the bag wall, wherein the third chamber bag outlet port is in fluid communication with the third bag chamber;
a pressurized-gas-receiving valve port connected to the bag wall, wherein the pressurized-gas-receiving valve port is in fluid communication with the first bag chamber; and,
a reverse osmosis filter assembly having a reverse osmosis filter, a reverse osmosis inlet port, wherein the reverse osmosis inlet port is connected to the first chamber bag outlet port, a reverse osmosis outlet port, wherein the reverse osmosis outlet port is connected to the third chamber bag outlet port; and a reverse osmosis retentate port, wherein the reverse osmosis retentate port is connected to the second chamber bag outlet port.

18. The water purification apparatus of claim 17 further comprising a soda siphon style valve cartridge, wherein the pressurized gas-receiving valve port is a soda siphon style valve port, and wherein the soda siphon style valve cartridge is secured to the soda siphon style valve port.

19. The water purification apparatus of claim 17 further comprising a compressed air canister with a feed hose, wherein the pressurized gas receiving valve port is a Schrader valve port, and wherein the compressed air canister with feed hose is secured to the Schrader valve port.

20. The water purification apparatus of claim 17 further comprising a sip tube, wherein the sip tube has a distal end positioned within the third chamber bag and a proximal end extending out of the tri-chamber bag.
